(19) United States
(12) Patent Application Publication
(10) Pub. No.: US 2026/0368852 A1
(43) Pub. Date: Nov. 19, 2026

(54) GENERATIVE TECHNOLOGIES FOR IMPROVED SUPER RESOLUTION DIGITAL IMAGE COMPRESSION

(71) Applicant: REGENTS OF THE UNIVERSITY OF MICHIGAN, Ann Arbor, MI (US)

(72) Inventors: Ryan Landvater, Ypsilanti, MI (US); Ulysses Balis, Ypsilanti, MI (US)

(21) Appl. No.: 19/681,985

(22) Filed: May 19, 2026

Related U.S. Application Data
(60) Provisional application No. 63/916,417, filed on Nov. 12, 2025.
(60) Provisional application No. 63/808,328, filed on May 19, 2025.

(51) Int. Cl. G06T 3/4053; G06T 3/4046; H04N 19/132; H04N 19/136; H04N 19/30; H04N 19/436; H04N 19/91

(52) U.S. Cl. CPC G06T 3/4053; G06T 3/4046; H04N 19/132; H04N 19/136; H04N 19/30; H04N 19/436; H04N 19/91

(57) ABSTRACT

Generative technologies for improved super resolution digital image compression are disclosed. An example method includes generating, using a deterministic generative model and a first image portion having a first resolution, a prediction of a second image portion having a second resolution that is higher than the first resolution. The example method further includes encoding residual characteristics for the generated prediction, the residual characteristics representing differences between the generated prediction and the second image portion and storing the first image portion and the encoded residual characteristics without storing the second image portion. The example method further includes decompressing the first image portion to reconstruct the second image portion by retrieving the first image portion and the encoded residual characteristics; generating, by the deterministic generative model and based on the first image portion, the generated prediction; and combining the encoded residual characteristics with the generated prediction to reconstruct the second image portion.

### CROSS-REFERENCE TO RELATED APPLICATIONS

This application claims priority to U.S. Provisional Patent Application No. 63/808,328, entitled “Generative Technologies for Improved Super Resolution Digital Image Compression,” filed on May 19, 2025, and further claims priority to U.S. Provisional Patent Application No. 63/916,417, entitled “Generative Technologies for Improved Super Resolution Digital Image Compression,” filed on Nov. 12, 2025, the disclosure of each of which is hereby incorporated herein by reference.

### FIELD OF THE DISCLOSURE

The present disclosure relates generally to image compression/decompression for storage/retrieval and, more particularly, to technologies for improved high-resolution digital image compression using deterministic generative models.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

High-resolution images are paramount in numerous fields. For example, in the medical field, digital histopathology – also called whole slide imaging (WSI) – is a tool of rapidly evolving importance. WSI involves the rendering, transfer, and/or storage of tissue sections in a computer (e.g., byte) format that can be analyzed by a pathologist via a computer monitor. Typically, these tissue sections are represented by digital images at resolutions that exceed hundreds of thousands of pixels in each dimension. Such images are typically subdivided/compressed into tiled subregions and lower-resolution layers. All resolution layers and tiles are stored for later random-access rendering during pathologist review.

Existing approaches require storing all tiled subregions in precalculated resolution layers for rendering speed; however, such approaches demand significant storage capacity for a single case. These storage challenges faced by existing techniques are further compounded when considering the multiple slides per patient case within the plurality of patient cases diagnosed by pathologists annually. Further, conventional image compression methods, such as frequency decomposition including JPEG transforms or wavelet-based JPEG 2000 algorithms, fail to adequately compress such high-resolution images without sacrificing image quality. Indeed, within modern digital pathology departments of tertiary care health systems, patient volume can exceed 50-100,000 surgical cases annually. This often requires storage of millions of gigabytes per annum (potentially exceeding 3 petabytes annually). The inefficiencies of existing image techniques present potentially insurmountable technological challenges for storage.

### SUMMARY OF THE INVENTION

In some aspects, the techniques described herein relate to a computer-implemented method for improved digital image compression and retrieval, the computer-implemented method including: generating, by one or more processors using a deterministic generative model and a first image portion having a first resolution, a generated prediction of a second image portion having a second resolution that is higher than the first resolution; encoding, by the one or more processors using an encoder, residual characteristics for the generated prediction, the residual characteristics representing differences between the generated prediction and the second image portion; storing, by the one or more processors, the first image portion and the encoded residual characteristics in a storage location without storing the second image portion; and decompressing, by the one or more processors, the first image portion to reconstruct the second image portion by: retrieving the first image portion and the encoded residual characteristics from the storage location, generating, by using the deterministic generative model and based on the first image portion, the generated prediction, and combining the encoded residual characteristics with the generated prediction to reconstruct the second image portion.

In some aspects, the techniques described herein relate to a system for improved digital image compression and retrieval, the system including: one or more processors; and at least one memory storing processor-executable instructions that, when executed by the one or more processors, cause the one or more processors to perform operations including: generating, using a deterministic generative model and a first image portion having a first resolution, a generated prediction of a second image portion having a second resolution that is higher than the first resolution; encoding, using an encoder, residual characteristics for the generated prediction, the residual characteristics representing differences between the generated prediction and the second image portion; storing the first image portion and the encoded residual characteristics in a storage location without storing the second image portion; and decompressing the first image portion to reconstruct the second image portion by: retrieving the first image portion and the encoded residual characteristics from the storage location, generating, by using the deterministic generative model and based on the first image portion, the generated prediction, and combining the encoded residual characteristics with the generated prediction to reconstruct the second image portion.

In some aspects, the techniques described herein relate to one or more non-transitory computer-readable media storing processor-executable instructions that, when executed by one or more processors, cause the one or more processors to perform operations including: generating, using a deterministic generative model and a first image portion having a first resolution, a generated prediction of a second image portion having a second resolution that is higher than the first resolution; encoding, using an encoder, residual characteristics for the generated prediction, the residual characteristics representing differences between the generated prediction and the second image portion; storing the first image portion and the encoded residual characteristics in a storage location without storing the second image portion; and decompressing the first image portion to reconstruct the second image portion by: retrieving the first image portion and the encoded residual characteristics from the storage location, generating, by using the deterministic generative model and based on the first image portion, the generated prediction, and combining the encoded residual characteristics with the generated prediction to reconstruct the second image portion.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 illustrates an example computing environment for improved digital image decompression, in accordance with various aspects disclosed herein.

FIG. 2 illustrates an example WSI file having multiple resolution layers and tiles that may be rendered for viewing by a user, in accordance with various aspects disclosed herein.

FIG. 3 illustrates a deterministic generative model training sequence, in accordance with various aspects disclosed herein.

FIG. 4A illustrates an example compression sequence including residual determination, encoding, and storage for a generated prediction of a higher resolution image portion, in accordance with various aspects disclosed herein.

FIG. 4B illustrates an example decompression sequence including residual decoding and combination with the generated prediction of the higher resolution image portion in FIG. 4A, in accordance with various aspects disclosed herein.

FIG. 5 illustrates an example deterministic generative model architecture including a super-resolution convolutional neural network (SRCNN) and an optional adjacent feature CNN (AFCNN), in accordance with various aspects disclosed herein.

FIG. 6A illustrates an example single image portion decompression sequence, in accordance with various aspects disclosed herein.

FIG. 6B illustrates an example iterative layer and image portion decompression sequence, in accordance with various aspects disclosed herein.

FIG. 7 illustrates a first example method for improved digital image decompression, in accordance with various aspects disclosed herein.

FIG. 8 illustrates a second example method for improved digital image decompression, in accordance with various aspects disclosed herein.

FIG. 9 depicts an example multiuse GPU texture workflow, in accordance with various aspects disclosed herein.

FIG. 10 depicts an example frequency coefficient prediction workflow, in accordance with various aspects disclosed herein.

### DETAILED DESCRIPTION

As previously mentioned, WSI is the process of digitally acquiring high resolution images of tissue mounted on a glass slide or slide-free microscopy that can then be analyzed by a pathologist via a computer monitor. WSI requires very high-resolution images that can take a significant amount of time to capture and process. These image files, containing confidential patient information, may be hundreds of megabytes/gigabytes in size, which can make the data difficult to store. Digital image compression must be limited to ensure safety and efficacy of the digital images for diagnosis purposes. Taken as a whole, these difficulties pose a substantial barrier to implementation and limit practitioner adoption of WSI technology in favor of the conventional (physical) slide analysis techniques.

Many existing approaches attempt to alleviate these issues by maintaining the higher-resolution images in secure remote storage and only render specific tiles/portions (referenced herein as a “portion,” for ease of discussion) of the higher-resolution images when viewed by a pathologist. For example, a pathologist may scan across a low-resolution image and may zoom or otherwise focus on a specific region within the image. These existing systems may identify the pathologist’s region of interest and initiate rendering of the corresponding higher-resolution portions stored in memory or remotely. While such techniques may reliably create exact reconstructions of the high-resolution image data, the massive file size of such high-resolution images and volume of surgical specimens can quickly overwhelm most modern data storage solutions, leading to a lack of available storage space for new images and/or older images that should be maintained (e.g., for patient medical history continuity).

Further, many existing techniques rely on general image compression approaches, such as frequency decomposition methods including JPEG transforms or the wavelet-based JPEG 2000 algorithm. However, these encoding methods ignore the unique visual characteristics and tissue structures of WSI data, which often exhibit repeated textures and highly uniform color palettes (referenced herein as high “visual redundancy”). Existing frequency decomposition techniques convert spatial domain image data into frequency domain data representing the image’s pixel values in terms of different frequency components. This transformation is therefore based on mathematical properties (e.g., amplitude, frequency) rather than directly on the image’s visual features. Even predictive encoding techniques that may incorporate some regional features generally do not incorporate global redundant information that is a hallmark of WSI data. As a result, existing compression techniques may not adequately leverage the significantly visual redundancy inherent to WSI data, leading to non-optimal compression and increased storage demands.

These existing frequency compression techniques also can fail to retain the intricate textures, fine edge details, and/or specific patterns that are non-trivial and characteristic of WSI data at higher compression ratios. Frequency-based compression, for example, prioritizes minimizing appreciable visual loss for the human vision system across diverse image domains, and consequently introduces some measure of high-frequency information loss into the image compression. However, such information loss is unacceptable in scenarios, e.g., where the image interpretation by a pathologist functions as a laboratory test. These gaps and/or otherwise erroneous image features within the high-frequency domain of high-resolution images may impact accuracy (e.g., diagnostic accuracy) and reproducibility. Thus, existing compression techniques may fail to achieve the degree of compression required in fields reliant on high-fidelity and high-reproducibility.

In order to alleviate these, and other, issues, the present disclosure provides techniques for improved digital image decompression. Generally, the techniques described herein leverage deterministic generative models to create deterministic predictions and encoded residuals of higher-resolution image portions. During compression, the deterministic generative model utilizes a low-resolution image portion to generate a prediction of a higher-resolution image portion. The difference between this generated prediction and the actual higher-resolution image portion – termed the “residual” – is then encoded or used to guide entropy encoding, and the result stored with the low-resolution image portion. The higher-resolution image portion is not stored.

During decompression, the present systems retrieve the low-resolution image portion and the encoded residual characteristics (residuals) from storage and input the low-resolution image portion into the deterministic generative model, which again generates the prediction (also referenced herein as a “generated prediction”) of the higher-resolution image portion. The present systems then combine this generated prediction with the residual to reconstruct the higher-resolution image portion. Accordingly, these deterministic predictions, in combination with their encoded residuals, can achieve lossless (exact) reconstructions of the higher-resolution image portions without requiring storage of the higher-resolution image portions.

Instead, the present techniques store only the lowest resolution (and thereby lowest file size) image portions and the residual characteristics corresponding to the higher-resolution image portions. The combined file size of such low-resolution image portions and the encoded residuals is significantly less than the file size of the higher-resolution image portions themselves, resulting in substantially reduced storage capacity requirements. Moreover, the deterministic generative model, as described herein, operates in a manner that establishes a direct and unambiguous mapping between individual input image portions and the corresponding output generated predictions. This deterministic nature ensures a consistent and predictable relationship where specific inputs consistently yield specific outputs. As the residuals contain the only additional information required to accurately reconstruct the higher resolution images, the data stored by the present techniques ensures minimal loss/lossless compression by ensuring residuals exactly match deterministically generated predictions of the higher resolution images.

Further, as the present techniques only require the lowest resolution image data and a set of residuals to reconstruct all corresponding higher resolution image data, the storage capacity reduction achieved by the present techniques continues to increase over the requirements of existing techniques as the number of resolution layers (each comprising one or more image portions) increases. For example, in a first scenario involving a single high-resolution layer (e.g., two total layers, comprising a high- and low-resolution layer), the present techniques reduce storage capacity requirements relative to existing techniques in proportion to the file size difference between the single high-resolution layer and the encoded residuals corresponding to that layer. In a second scenario involving four high-resolution layers (e.g., five total layers), the present techniques reduce storage capacity requirements relative to existing techniques in proportion to the file size difference between the combined file size of all four high-resolution layers and the combined file size of the encoded residuals corresponding to each of the four layers. As file size differences between residuals of higher resolution images and lower resolution images tend to scale less significantly than the file size differences between the images themselves, the present techniques achieve clear and significant storage capacity requirement advantages over existing techniques that rely on higher resolution image storage.

In certain embodiments, the deterministic generative model utilizes SRCNNs and AFCNNs to reconstruct image portions from residuals, lower-resolution, and optionally adjacent image input data dynamically. This hierarchical reconstruction process iteratively generates high-resolution predictions with deterministic consistency, and the AFCNNs may be integrated to further enhance high-resolution image fidelity by incorporating contextual information from neighboring image tiles at the high-resolution layer. By incorporating such local and global image information, the present techniques achieve higher accuracy compared to existing approaches, which often fail to augment with the full contextual detail necessary for many high-resolution image use-cases (e.g., WSI). The deterministic nature of these generative models (specifically neural networks) ensures precise image generation, mitigating the possibility of distortions or diagnostic inaccuracies during reconstruction, and the AFCNNs may further reduce storage capacity requirements by improving the generative predictions and thereby minimize the amount of data consumed by the residuals.

The present techniques also address specific challenges inherent to digital pathology data. As previously mentioned, WSI exhibits a relatively constrained image vocabulary characterized by dichromatic staining and repetitive textures based on tissue architecture and cytological features. This visual redundancy is exploited at least by the entropy encoding applied with the residual characteristics prior to storage. When data has high visual redundancy, the patterns, repetitions, and/or uniformity in the data can be leveraged by predictive algorithms for significantly improved compressed representation relative to non-entropy-based encoding schemes. Entropy encoding algorithms, (e.g., Huffman coding or arithmetic coding), generally utilize statistical properties of the data to assign variable-length codes to symbols based on their probabilities of occurrence. By assigning shorter codes to more frequent symbols (and patterns) and longer codes to less frequent symbols, entropy encoding optimally represents the data in a compressed form. Thus, the entropy encoding guided by the residual characteristics produced using the present techniques minimizes file size relative to other existing methods.

Moreover, in certain embodiments, individual deterministic generative models may be trained/tailored to specific image data types (e.g., tissue types, staining methodologies, etc.). By focusing on distinct image data types, the resulting models may be further tuned to provide highly optimized networks for specific domains, such as cancerous colon cells, lung tissue morphology, or other histologically distinct features, each of which may have even higher visual redundancy, creating more reliable decompression predictions to further reduce the file size of the required residuals.

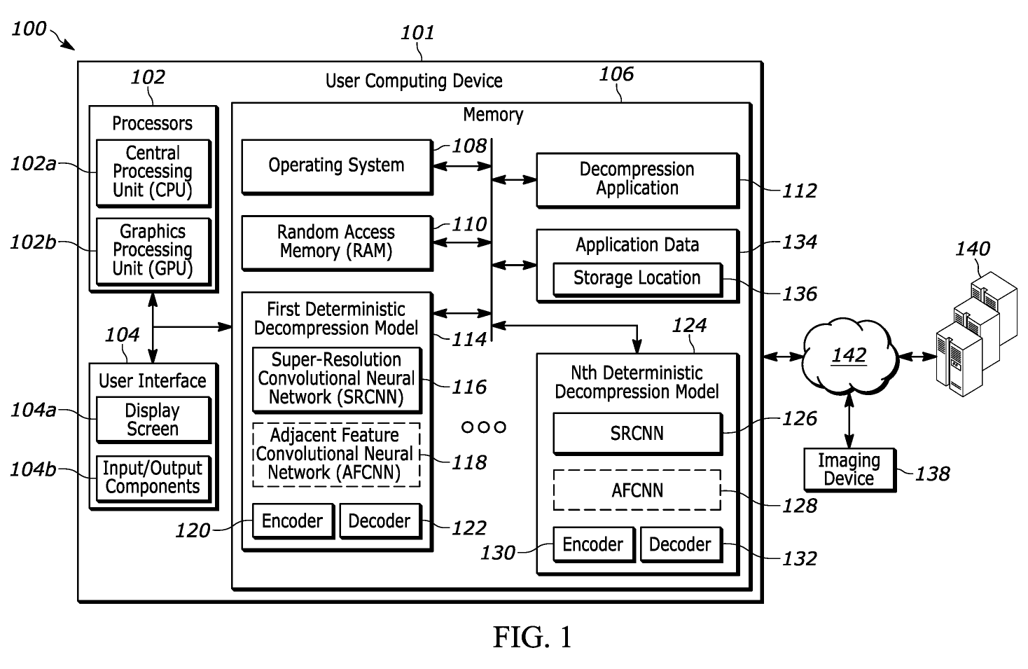

Turning to the Figures, FIG. 1 illustrates an example computing environment 100 for generative improved super-resolution digital image decompression. As illustrated in FIG. 1, the example computing environment 100 may include a user computing device 101 that includes a processor 102, a user interface 104, and a memory 106. The processor 102 may have a central processing unit (CPU) 102a and a graphics processing unit (GPU) 102b.

Generally speaking, both the CPU 102a and the GPU 102b may access the memory 106 to execute instructions included therein, such as the operating system 108, the decompression application 112, the first deterministic generative model 114, the Nth deterministic generative model 124, the application data 134, and/or to access data or instructions stored in the random-access memory (RAM) 110. The CPU 102a may be configured to execute a wide range of tasks stored in the memory 106, such as dividing and sub-dividing whole slide images into resolution layers and/or tiles. The GPU 102b may be configured to perform tasks associated with rendering the whole slide images for viewing by a user. Of course, it should be understood that the CPU 102a and the GPU 102b may perform additional tasks not described herein. Further, it should be appreciated that the example computing environment 100 is merely an example and that alternative or additional components are envisioned.

More specifically, the user computing device 101 may receive multiple layers of image data from the imaging device 138, with each layer containing a different resolution. The device 101 may execute a decompression application 112 to compress/decompress the image data, and the application 112 may utilize a first deterministic generative model 114 to achieve this compression/decompression. The first deterministic generative model 114 may generally be configured to generate decompression predictions of higher resolution images using the corresponding lower resolution images as inputs. In certain embodiments, this model 114 comprises a generative neural network that incorporates a SRCNN 116 and an AFCNN 118 to create the generated prediction.

Additionally, the memory 106 may store any suitable number of deterministic generative models, such as the Nth deterministic generative model 124 (where N is any integer value), and each model 114 and 124 may comprise an SRCNN 116 and 126, an encoder 120 and 130, a decoder 122 and 132, and an optional AFCNN 118 and 128. However, for ease of discussion, further reference to the deterministic generative models will be made to the first deterministic generative model 114 and subcomponents thereof. Further, it should be appreciated that the deterministic generative models 114 and 124 may comprise less than each of the components illustrated in FIG. 1, alternative generative machine learning models, and/or that some components may be included as part of other components in the memory 106 (e.g., encoders/decoders stored as part of the application 112).

The compression performed by the deterministic generative model 114 generally comprises analyzing an input low-resolution image portion to output a prediction of a higher-resolution image portion. This decompression may be performed by the SRCNN 116, which should be understood to be any type of deep learning model specifically configured to enhance the resolution and quality of an input image. The SRCNN 116 may utilize multiple convolutional layers to generate hierarchical features from the low-resolution input image received from the imaging device 138. For example, in certain embodiments, the SRCNN 116 may include feature extraction layers, various generative layers, and up-sampling layers such as periodic shuffling. The SRCNN 116 may then extract, by executing operations of the feature extraction layer, features of the lowest resolution image portion into a feature map; generate features of higher resolution layers using the feature map of the lowest resolution image portion; and upsample, by executing operations of the strided convolution layer, the generated high resolution feature map from the lowest resolution image portion.

In any event, these convolutional layers capture and analyze various image features at different levels of abstraction. The SRCNN 116 may then pass these features through non-linear mapping layers to learn complex relationships between the low-resolution input and high-resolution output images and reconstruct the high-resolution image by synthesizing new pixel values based on the learned mappings and extracted features. These relationships may be further enhanced by attention mechanisms, referred to as “transformer” architectures. The SRCNN 116 may ultimately generate a prediction as an output, aiming to closely match the prediction with the original high-resolution image.

During training, the model 114 and/or other suitable components may train the SRCNN 116 using loss functions that compare the generated prediction with ground truth high-resolution images (e.g., received from the imaging device 138), with the goal of minimizing the difference between them. However, given that the SRCNN 116 training is unlikely to yield generated predictions that perfectly reconstruct the original high-resolution images without errors in every instance, the model 114 may be configured to determine residual characteristics representing the difference between the generated predictions output, as well as additional characteristics such as model uncertainty, by the SRCNN 116 and the high-resolution images received from the imaging device 138. The residuals may themselves be images having identical/similar dimensions as the low/high resolution images and generated prediction, and together may reflect the additional information needed to reconstruct the original high-resolution image accurately from its generated prediction.

In certain embodiments, the model 114 may apply the encoder 120 to determine and/or encode the residuals. The encoder 120 may generally be configured to calculate the difference between the original high-resolution image data and its generated prediction to generate residuals that capture the additional information required for accurate reconstruction. The encoder 120 may thereafter apply compression techniques to the residuals, such as entropy encoding or differential encoding, to efficiently encode and represent the differential information in a compact form suitable for storage. For example, the residual may be a stochastic residual and the encoder 120 may be an entropy encoder configured to use occurrence frequencies of data comprising the stochastic residuals, referred to as the probability of residual symbols, and model certainty to produce an entropy encoded symbol sequence having a file size dependent upon the asymmetric frequency of symbols and upon model certainty.

In certain embodiments, the residual characteristics may be integrated cumulative stochastic residual characteristics that aggregate multiple types of difference information associated with the generated prediction and the second image portion. For example, the integrated cumulative stochastic residual characteristics may include pixel-by-pixel value differences, model uncertainty metrics, and/or statistical distribution characteristics that collectively represent the information needed to reconstruct the higher-resolution image portion (e.g., the second image portion) from the generated prediction.

By encoding only the residual data, the encoder 120 may focus on compressing the essential information needed for reconstruction, optimizing compression ratios and minimizing storage requirements. Indeed, the decompression application 112 may store the lowest resolution images and the encoded residuals in the storage location 136 to reduce the overall data size, leading to more efficient utilization of storage space in the application data 134 while ensuring that the reconstructed image maintains its quality and fidelity during the decoding process. In some embodiments, the lowest resolution image portion has a first file size, the higher resolution image portion has a second file size, the encoded residual has a third file size, and the second file size is greater than a combination of the first file size and the third file size.

In embodiments where the deterministic generative model 114 includes the AFCNN 118, the AFCNN 118 may provide fine tuning of generated details using information regarding the character and/or intensity of image features from adjacent image portions (e.g., pixels, tiles) to generate a higher fidelity upsampled image portion (e.g., generated prediction). The AFCNN 118 may generally extract relevant features from adjacent image portions to capture contextual information that can improve the understanding of the local image content. By considering information from neighboring image portions, the AFCNN 118 may enable the SRCNN 116 to better model relationships within the image and refine the generated predictions based on the characteristics and intensity of these adjacent features.

For example, in certain embodiments, the model 114 may generate the prediction based at least in part on (i) a downsampled image portion corresponding to the lower resolution image portion, (ii) the encoded residuals, and (iii) a decompressed image portion corresponding to one or more image portions that are proximate to the lower resolution image portion in the lower resolution image layer, the decompressed image portions having been mixed with their corresponding associated residuals. In some embodiments, the model 114 may upsample a downsampled feature map at least in part by generating, using the AFCNN 118, an adjacent feature map associated with at least one image portion that is adjacent to the lowest resolution image portion used to generate the prediction; and upsample, based at least in part on the adjacent feature map, the downsampled feature map of the lowest resolution image portion. In certain embodiments, the model 114 may upsample a downsampled image layer at least in part by generating, using the AFCNN 118, an adjacent higher resolution image associated with at least one image portion that is adjacent to the lower resolution image portion used to generate the prediction; and upsample, based at least in part on the adjacent higher resolution image, the downsampled image layer of the lower resolution image portion.

In any event, when the deterministic generative model 114 completes the compression processes, it outputs a set of residuals that correspond to the higher resolution images received from the imaging device 138. The decompression application 112 then stores the lowest resolution images (e.g., comprising the lowest resolution image layer) and the set of residuals for up to all higher resolution image layers in the storage location 136 of the application data 134. The decompression application 112 may also discard the higher resolution images, transmit them to another location for remote storage (e.g., external servers 140), and/or otherwise not store the higher resolution images received from the imaging device 138. When the decompression application 112 determines that one or more of the higher resolution image portions should be decompressed, the application 112 may retrieve a corresponding lowest resolution image portion and encoded residual from the storage location 136 and transmit this data to the deterministic generative model 114.

When decompressing image portions, the deterministic generative model 114 may utilize the decoder 122 to decode the encoded residual. The decoder 122 may obtain the encoded residuals that were generated during the compression process and may reverse the compression process by using inverse compression techniques (e.g., inverse entropy encoding) to recreate the detailed information that was omitted during compression (e.g., by the SRCNN 116 generating the prediction). The decoded residual information can then be added or combined with the generated prediction to reconstruct the higher resolution image portion. In certain embodiments, the decoder 122 may combine the decoded residual with the generated prediction to achieve the higher resolution image portion. In certain embodiments, the encoder 120 and decoder 122 may be collectively represented by an autoencoder that combines an encoder and a decoder into a single neural network, where the input and output are the same. This autoencoder network may be trained to reconstruct the input at the output layer, while the intermediate layer or layers (e.g., the latent space) may learn to capture the features of the input data.

The deterministic generative model 114 may also input the lowest resolution image portion into the SRCNN 116. The SRCNN 116 may then generate the same prediction corresponding to the lowest resolution image portion the SRCNN 116 generated during the initial compression. The deterministic generative model 114 may then combine the generated prediction and the decoded residual to generate the complete higher resolution image portion.

In certain embodiments, the deterministic generative model 114 may decompress multiple image portions from a same resolution image layer in parallel. For example, the model 114 may decompress in parallel (i) a first image portion to reconstruct a second image portion and (ii) a third image portion to reconstruct a fourth image portion, wherein the third image portion and the first image portion are both included as part of a same resolution image layer (e.g., the lowest resolution layer). Accordingly, the first image portion and the third image portion may have a same (first) resolution and the second image portion and the fourth image portion may have a same (second) resolution that is greater/higher than the first resolution.

In certain embodiments, each of the deterministic generative models 114 and 124 may be trained to compress/decompress distinct image data types. These distinct image data types may include distinct tissue types (e.g., cancerous colon cells, lung tissue morphology, or other histologically distinct features), staining methodologies, microscopy techniques (e.g., brightfield, fluorescence, confocal imaging), cellular structures (e.g., nuclei, cytoplasm, cell membranes), tissue preparations (e.g., frozen sections, paraffin-embedded tissues), imaging modalities (e.g., MRI, CT scans, ultrasound), or medical imaging applications (e.g., radiology, pathology, dermatology), and/or other suitable data types or combinations thereof. Thus, these individual deterministic generative models may be trained using a plurality of training data that is comprised of the single image data type the model is intended to analyze. This single image data type training process may minimize information entropy during the training process, such that the resulting trained models are specialized/optimized to effectively and accurately compress and decompress the specific image data type it was trained on. These models may then have significantly enhanced performance and precision in handling complex image datasets within the designated image data type.

Additionally, or alternatively, the deterministic generative models 114 and 124 may be trained to compress/decompress images having different resolutions. For example, the first deterministic generative model 114 may be trained/configured to generate a prediction having a resolution that is higher than the predictions generated by the Nth deterministic generative model 124.

Moreover, as a result of cross-training, the deterministic generative model 114 may be trained/configured to generate the predictions using a different number or configuration of layers (e.g., single convolutional layer). As an example, the application 112 and/or other suitable components may train a multi-layered SRCNN (e.g., of Nth deterministic generative model 124) using the dataset of low-resolution and high-resolution image pairs. After training the multi-layered SRCNN, the application 112 may obtain intermediate outputs or feature maps from specific layers of the network corresponding to the images and may use these intermediate outputs to train a single-layer SRCNN to learn and mimic the behavior of the multi-layer SRCNN in generating predictions. The application 112 may further define an appropriate loss function criterion that measures the difference between the outputs generated by the single-layer SRCNN and the multi-layered SRCNN and optimize the single-layer SRCNN using backpropagation, gradient descent, and/or any other suitable tuning mechanism(s) to minimize this loss and fine-tune the SRCNN to replicate the behavior of the multi-layered SRCNN.

In certain embodiments, the deterministic generative models 114 and/or 124 may comprise alternative approaches that may not utilize and/or otherwise rely on neural networks, including polynomial interpolation techniques or combinations of generative neural networks with polynomial methods. Polynomial interpolation represents a mathematical approach to image super-resolution that uses polynomial functions to estimate pixel values at higher resolutions based on known pixel values from lower resolution images. Such techniques may involve fitting polynomial curves or surfaces through existing pixel data points and using these mathematical functions to predict intermediate pixel values, thereby upsampling the image to a higher resolution.

In particular, polynomial interpolation methods may include the processors described herein (e.g., 102) analyzing the spatial relationships between pixels in the lower resolution image and applying mathematical formulas to generate smooth transitions and predict missing pixel information. These techniques may utilize various polynomial orders, such as linear, quadratic, and/or cubic interpolation, where higher-order polynomials may capture more complex pixel relationships but may also introduce computational overhead. The interpolation process may involve calculating coefficients for polynomial equations that best fit the existing pixel data and then evaluating these equations at new pixel locations to generate the higher resolution output.

The results achieved by these polynomial interpolation techniques may differ from neural network-based approaches in several ways. Polynomial methods may produce smoother interpolated results but may lack the ability to reconstruct fine textural details and complex patterns that neural networks can learn from training data. For example, spline interpolation, which represents a piecewise polynomial approach that connects data points with smooth curves, may offer improved continuity and flexibility compared to single polynomial methods by allowing different polynomial segments to be fitted across different regions of the image data. Neural networks may also demonstrate superior performance in preserving edge sharpness and reconstructing intricate tissue structures commonly found in whole slide images, while polynomial approaches may tend to produce more generalized, mathematically smooth results. Polynomial interpolation may offer computational advantages in terms of processing speed and memory requirements, as these methods typically involve direct mathematical calculations rather than the matrix operations required by neural networks. However, the deterministic generative models 114 and/or 124 may also incorporate hybrid approaches that combine the computational efficiency of polynomial interpolation with the learning capabilities of neural networks to achieve balanced performance in both accuracy and processing efficiency.

The user computing device 101 further includes a user interface 104 configured to present/receive information to/from a user. As shown in FIG. 1, the user interface 104 may include a display screen 104a and I/O components 104b (e.g., ports, capacitive or resistive touch sensitive input panels, keys, buttons, lights, LEDs). According to some aspects, a user may access the user computing device 101 via the user interface 104 to review outputs from the processors 102 (e.g., executing the deterministic generative model 114), adjust a current view region of a particular whole slide image, make various selections, and/or otherwise interact with the user computing device 101 and the example computing environment 100.

In particular, the user may interact with the I/O components 104b in order to adjust a current view region to view a new portion of a particular whole slide image. As discussed further herein, the processors 102 may receive an indication of the new portion of the particular whole slide image that is featured on the current view region, and may respond accordingly by executing instructions included as part of the decompression application 112 to decompress and adjust the tiles/resolution layers presented on the display screen 104a to the user to reflect the new portion of the particular whole slide image.

The memory 106 may store an operating system 108 capable of facilitating the functionalities as discussed herein, the RAM 110, the decompression application 112, the deterministic generative models 114 and 124, as well as the application data 134. The application data 134 may include a set of applications configured to facilitate the functionalities as discussed herein, and/or may include other relevant data, such as the storage location 136 including the lowest resolution images and residuals, etc. It should be appreciated that one or more other applications are envisioned. Moreover, it should be understood that any processor (e.g., processor 102), user interface (e.g., user interface 104), and/or memory (e.g., memory 106) referenced herein may include one or more processors, one or more user interfaces, and/or one or more memories.

In any event, the memory 106 may include one or more forms of volatile and/or non-volatile, fixed and/or removable memory, such as read-only memory (ROM), electronic programmable read-only memory (EPROM), the RAM 110, the video random access memory (VRAM), erasable electronic programmable read-only memory (EEPROM), and/or other hard drives, flash memory, MicroSD cards, and others.

The example computing environment 100 also includes an imaging device 138 that is configured to capture images of tissue samples that are mounted on slides. When a tissue sample is mounted on a slide, the imaging device 138 may capture multiple images of the tissue sample at, for example, multiple resolutions. The imaging device 138 may also capture multiple high-resolution images of the slide that feature a portion of the slide that is less than the whole of the slide, such that the device 138 captures enough high-resolution images of the slide to stitch together a complete, high-resolution image of the slide. For example, as previously mentioned, the imaging device 138 may capture multiple images (e.g., tiles) of the slide, so that the tiles may thereafter be stitched together to form the high-resolution image of the slide. It should be understood that the imaging device 138 may capture any suitable number of images of the slide at any suitable resolution.

Moreover, in some aspects, the components of the example environment 100 may perform the functionalities as discussed herein as part of a “cloud” network or may otherwise communicate with other hardware or software components within the cloud to send, retrieve, or otherwise analyze data. Thus, it should be appreciated that the example computing environment 100 may be/include a distributed cluster of computers, servers, machines, or the like. In this implementation, a user may utilize the distributed example computing environment 100 as part of an on-demand cloud computing platform. Accordingly, when the user interfaces with the example computing environment 100 (e.g., by capturing images of a slide using the imaging device 138, uploading captured images to the user computing device 101), the example computing environment 100 may actually interface with one or more of a number of distributed computers, servers, machines, or the like, to facilitate the described functionalities.

For example, the user computing device 101 may communicate and interface with an external server 140 via a network(s) 142. The external server 140 may be, for example, a remote storage location for the digital images of slides, and may receive the captured digital images of each slide from the user computing device 101 after analysis from a pathologist (or other specialist) and/or directly from the imaging device 138.

Further in these aspects, the network(s) 142 used to connect the user computing device 101 to the imaging device 138 and/or the external server 140 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). Moreover, the imaging device 138 and/or the external server 140 may include a memory as well as a processor, and the memory may store an operating system capable of facilitating some/all of the functionalities as discussed herein.

Additionally, it is to be appreciated that a computer program product in accordance with an aspect may include a computer usable storage medium (e.g., standard RAM, an optical disc, a universal serial bus (USB) drive, or the like) having computer-readable program code embodied therein, wherein the computer-readable program code may be adapted to be executed by the processor(s) 102 (e.g., working in connection with the operating system 108) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some aspects, the computer program product may be part of a cloud network of resources.

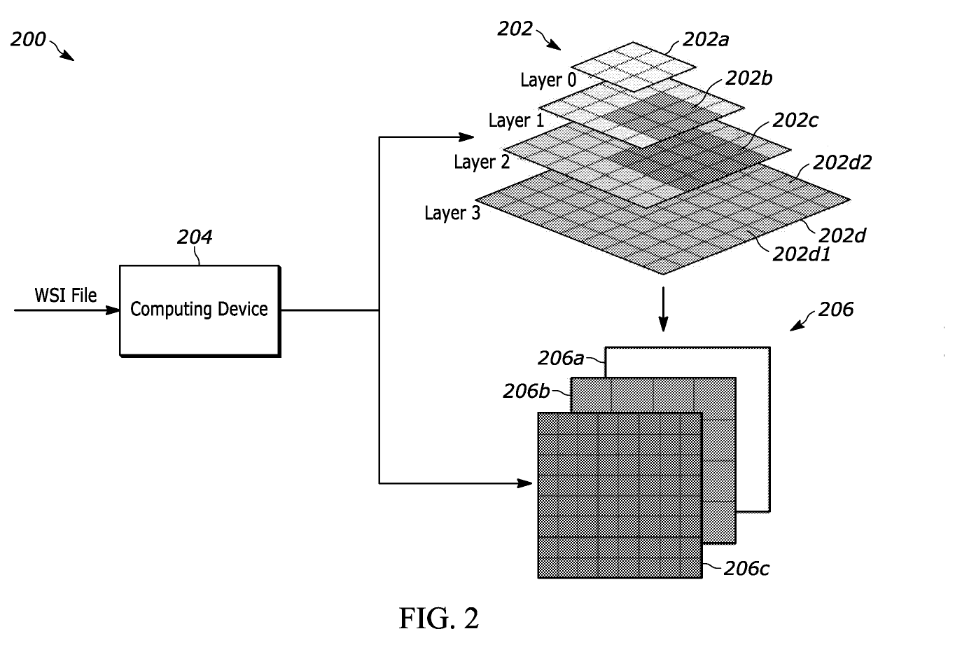

FIG. 2 illustrates an example WSI file having multiple resolution layers and tiles that may be rendered for viewing by a user, in accordance with various aspects disclosed herein. FIG. 2 includes an example workflow 200 wherein a set of WSI tiles 202 that represent a slide at various levels of resolution, a computing device 204, and a set of visible image tiles 206 rendered by a GPU (e.g., GPU 102b) and/or other suitable processing device. The set of WSI tiles 202 may be generated by a CPU (e.g., CPU 102a) and/or other suitable processing device after receiving a slide image file (not shown) containing images of a particular slide captured by an imaging device (e.g., imaging device 138). The set of visible image tiles 206 may include image tiles that are rendered for display/viewing to/by a user (e.g., a pathologist) during diagnosis of conditions represented in the tissue sample featured in the slide images, and the tiles 206 may include multiple visible image layers 206a, 206b, and 206c . The computing device 204 may include components of the example computing environment 100 of FIG. 1 that are configured to perform actions relevant to the set of WSI tiles 202 and/or the set of visible image tiles 206.

Generally speaking, the computing device 204 may receive a WSI file containing multiple images of the slide captured by the imaging device (e.g., imaging device 138). The computing device 204 may divide the images in the image file into the resolution layers 202a-d and may then sub-divide the individual resolution layers 202a-d into tiles. For example, the computing device 204 may receive the image file corresponding to the slide represented in the resolution layers 202a-d, the computing device 204 may divide the image file into the respective resolution layers 202a-d and may then sub-divide the resolution layers 202a-d into tiles, such as tiles 202d1, 202d2 of the fourth resolution layer 202d. In certain aspects, each tile (e.g., tiles 202d1, 202d2) is a 256x256 pixel sub-image of the corresponding resolution layer 202a-d, and as a result, the number of tiles corresponding to each resolution layer 202a-d is directly proportional to the number of pixels within the respective resolution layer 202a-d.

For example, the first resolution layer 202a may represent the slide at a lowest relative level of resolution, the second resolution layer 202b may represent the slide at a second lowest relative level of resolution, the third resolution layer 202c may represent the slide at a second highest relative level of resolution, and the fourth resolution layer 202d may represent the slide at a highest relative level of resolution. Accordingly, in this example, the first resolution layer 202a may include a first number of tiles, the second resolution layer 202b may include a second number of tiles that is greater than the first number of tiles, the third resolution layer 202c may include a third number of tiles that is greater than the second number of tiles, and the fourth resolution layer 202d may include a fourth number of tiles that is greater than the third number of tiles. As illustrated in FIG. 2, four resolution layers may be utilized as part of the present techniques, but it should be understood that any suitable number of resolution layers may be utilized.

When the computing device 204 has divided and sub-divided the slide image file into resolution layers 202a-d that each contain multiple tiles (e.g., tiles 202d1, 202d2), the computing device 204 may render the tiles for viewing by a user (e.g., in one of the visible image layers 206a, 206b, 206c). The tiles may be drawn by the computing device 204 using image abstractions of the tissue sample represented in the tiles, and the image abstractions may contain a subsampling of the image data included in any particular tile and/or set of nearby tiles.

The computing device 204 may also map the image tiles in the resolution layers 202a-d to the visible image layers 206a-c in accordance with their respective resolutions. For example, the device 204 may map tiles from the second resolution layer 202b to the second visible image layer 206b and may map tiles from the third resolution layer 202c to the third visible image layer 206c. These mappings may correspond to a fixed-dimension current view region, which may be or otherwise correspond to the dimensions of a display screen (e.g., display screen 104a). As a simple example, the current view region may include 10x10 high-resolution image tiles and 4x4 lower-resolution image tiles.

The present techniques enable the computing devices described herein (e.g., computing device 204) to avoid storing the higher resolution layers (e.g., layers 202b-d) of the WSI file, while still being able to render these higher resolution layers 202b-d. The computing device 204 may receive the WSI file and may utilize the lowest resolution layer 202a in combination with the deterministic generative models described herein to generate decompression predictions and residuals associated with the higher resolution layers 202b-d and their corresponding tiles (e.g., 202d1, 202d2). The computing device 204 may then store the lowest resolution layer 202a and the residuals corresponding to the higher resolution layers 202b-d to later decompress the layer 202a into exact reconstructions of these layers 202b-d using the residuals in combination with the generated predictions of the deterministic generative models. Accordingly, the present techniques dramatically reduce the amount of long-term storage required to render and display such high resolution (and correspondingly large file size) images (e.g., whole slide images).

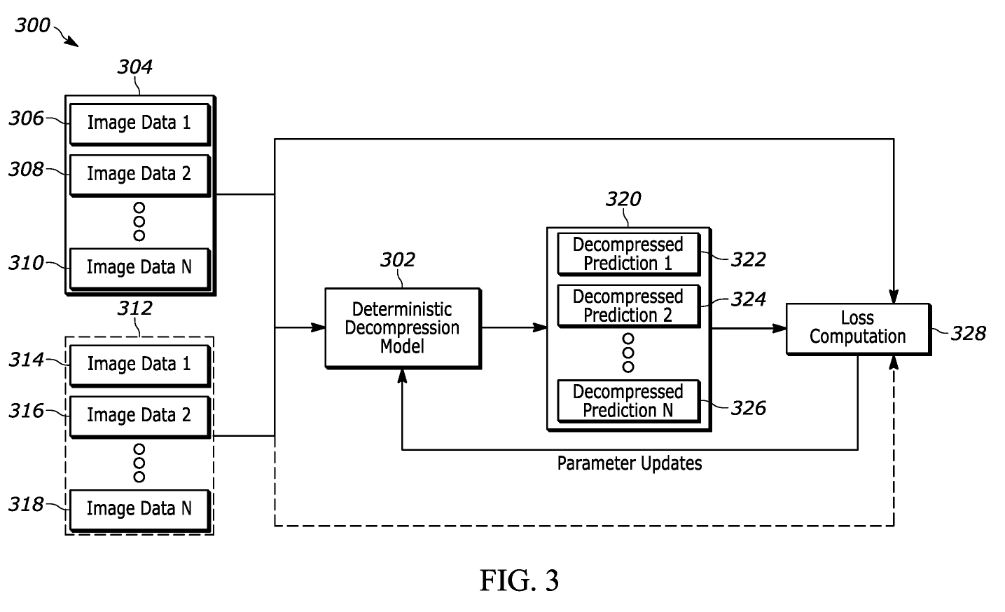

FIG. 3 illustrates a deterministic generative model training sequence 300, in accordance with various aspects disclosed herein. The training sequence 300 generally includes training a deterministic generative model 302 with training data to output training generated predictions, determining a loss value based on the differences between the input training images and the output training generated predictions, and updating the model 302 parameters based on the loss values. As a result, of the training sequence 300, the deterministic generative model 302 may receive input image data and output a generated prediction, from which, the systems described herein may determine a residual.

More specifically, the deterministic training model 302 may be a SRCNN, and training a SRCNN generally involves feeding the network with pairs of low-resolution images and their corresponding higher resolution counterparts to learn the mapping between the two. The model 302 may be trained using a dataset of such image pairs (e.g., sets of training data 304, 312), where the low-resolution images are downsampled versions of the higher resolution images.

During training, the deterministic training model 302 may iteratively learn to extract features from the low-resolution inputs, upscale them, and reconstruct higher-resolution versions (e.g., the set of generated predictions 320) that closely match the ground truth higher resolution images. The systems described herein may then adjust the model's 302 parameters through optimization algorithms to minimize the difference (loss) between the predicted higher resolution images and the true higher resolution images in the sets of training data 304, 312. As an example, the optimization algorithms may be or include a stochastic gradient descent algorithm, an adaptive moment estimation (ADAM) optimizer algorithm, a root mean square (RMS) propagation algorithm, an adaptive gradient algorithm, and/or any other suitable algorithm(s) or combinations thereof.

Accordingly, the deterministic generative model training sequence 300 may include a set of training data 304 that includes a first set of image data 306, a second set of image data 308, and up to an Nth set of image data 310 (where N is any integer value greater than zero). The first set of image data 306, the second set of image data 308, and/or up to the Nth set of image data 310 may include one or more image pairs and/or image portion pairs, such as whole slide images, including pairs of low-resolution and higher resolution images/image portions. For example, the first set of image data 306 may include one or more image pairs of a first image data type (e.g., lung tissue samples with cancerous cells) and the second set of image data 308 may include one or more image pairs of a second image data type (e.g., colon tissue samples with cancerous cells). The deterministic generative model 302 may then be trained to generally reconstruct the higher resolution images/image portions of various tissue samples with cancerous cells from the low-resolution images/image portions.

In certain embodiments, the set(s) of training data 304, 312 used to train the deterministic generative model 302 may be or include a single image data type. For example, the first set of image data 306, the second set of image data 308, and up to the Nth set of image data 310 may each be or include image data corresponding to lung tissue samples with cancerous cells. The training process may thus involve the deterministic generative model 302 creating a set of generated predictions 320 associated specifically with lung tissue samples with cancerous cells, such that each of the first generated prediction 322, the second generated prediction 324, and up to the Nth generated prediction 326 may be a predicted reconstruction of a corresponding higher resolution image/image portion representing the lung tissue samples with cancerous cells from the set(s) of training data 304, 312. The training sequence 300 may then determine/compute the loss values associated with up to each of the generated predictions 320 and apply parameter updates/adjustments to the deterministic generative model 302.

By training the model 302 with a single image data type, the present techniques may significantly improve the functioning of the model 302. Focusing on a specific type of image data allows the model 302 to learn the unique characteristics and patterns relevant to that domain, such that the model 302 may better capture the intrinsic features of the images/image portions and optimize its performance for that specific type of data. This improved understanding may also enhance the model’s 302 ability to generalize to unseen examples within the same domain. The model 302 may learn to encode the common structures, textures, and/or details specific to the input images, resulting in more accurate reconstruction predictions for higher resolution images of similar content.

For example, and as mentioned, whole slide images corresponding to a single image data type (e.g., bone samples, prostate tissue samples, colon tissue samples, lung tissue samples, etc.) generally possess a limited image vocabulary, resulting in a relatively low intra- and inter-image visual/information entropy. That is, whole slide images are often dichromatic (e.g., either stained with eosin and hematoxylin or with hematoxylin and a chromogen, in immunohistochemistry) and have repeating image textures based upon tissue type, tissue architecture, and cytologic features (e.g., cellular appearance). This limited image vocabulary represents a reduced visual/information entropy relative to many other image data types and thus enables the model 302 to encode these common features more accurately than for other image data types that are unrelated to WSI.

Additionally, by more accurately generating predictions of the higher resolution image data, the residuals generated and subsequently stored may require less storage space. The image residuals may contain the pixel-by-pixel differences between the predicted decompression and the ground truth high-resolution image, thereby representing the errors in the prediction made by the model and highlighting areas where the predicted image deviates from the ground truth image. In the case of a low-accuracy match, the image residuals are likely to be larger in size because the predicted image will have significant discrepancies compared to the ground truth high-resolution image, resulting in larger and more pronounced differences that need to be stored in the residuals and correspondingly higher storage requirements. Conversely, when the model 302 produces a high-accuracy match that closely approximates the ground truth image, the image residuals are generally smaller in size because there are fewer errors and discrepancies. The content of the image residuals would therefore contain minimal information (as the prediction is already accurate), requiring less data to represent the differences. Accordingly, having a high-accuracy match results in smaller image residuals to store because the predicted image closely resembles the ground truth image, reducing the amount of error information that needs to be encoded in the residuals.

Moreover, by training solely on one type of image data, the model 302 may converge faster during training iterations and achieve better reconstruction accuracy. The model 302 can effectively exploit the regularities and statistical properties inherent in the training data to generate high-quality, high-resolution outputs. Training with a single image data type may also help prevent the model 302 from overfitting to unrelated patterns or noise that may be present in a more diverse dataset. This targeted training approach minimizes the risk of the network learning irrelevant features and allows it to better capture the essential characteristics of the input images. Additionally, training the model 302 with such a homogeneous dataset may enable fine-tuning and optimization of the network architecture and hyperparameters specifically tailored to the characteristics of the input images. Overall, these advantages allow for more efficient utilization of computational resources and improved performance in reconstructing higher resolution images at least because the training process is substantially streamlined and the resulting trained model (e.g., model 302) generates more accurate high-resolution predictions than models trained using multiple image data types.

In certain embodiments, the training data used to train the deterministic generative model 302 may include a second set of training data 312 that includes a first set of image data 314, a second set of image data 316, and up to an Nth set of image data 318 (where N is any integer value greater than zero). The first set of training data 304 may include image data associated with a first image data type, and the second set of training data 312 may include image data associated with a second image data type that is different from the first image data type. Moreover, the training sequence 300 may include any suitable number of training data sets that include image data representative of any suitable number of image data types.

As illustrated in FIG. 3, the sets of training data 304, 312 may include higher resolution images that the systems described herein may utilize to determine/compute loss values associated with the set of generated predictions 320 output by the model 302 (as indicated by the arrows extending from the sets of image data 304, 312 to the loss computation 328). The systems described herein may further utilize these loss values to determine parameter updates for the model 302. These parameter updates may be or include updates to the model’s 302 weights and/or biases, hyperparameter tuning, fine-tuning, regularization, learning rate scheduling, batch normalization, and/or any other suitable parameter updates or combinations thereof.

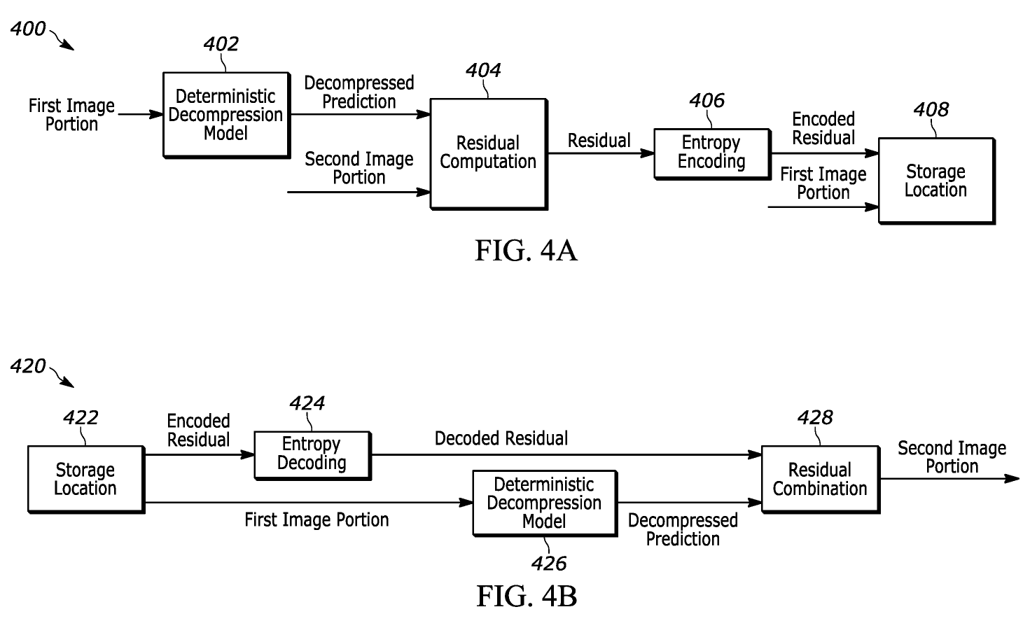

FIG. 4A illustrates an example compression sequence 400 including residual determination, encoding, and storage for a generated prediction of a higher resolution image portion, in accordance with various aspects disclosed herein. The example compression sequence 400 includes receiving a first image portion and a deterministic generative model 402 generating a prediction of the first image portion, the generated prediction being a prediction of a higher resolution version of the first image portion. A component described herein (e.g., decompression application 112 and/or model 114) may analyze this generated prediction and a second image portion to compute/determine a residual (block 404). The second image portion may be a ground-truth higher resolution version of the first image portion, and the residual may be an image comprised of image data representing the differences in pixel values and/or any other suitable values between the generated prediction and the second image portion. An encoder may receive this residual and encode the residual for storage (block 406). This encoded residual may be stored in a storage location 408 along with the first image portion and without the second image portion. In other words, at the conclusion of the example compression sequence 400 for the first image portion, the storage location 408 may include an encoded residual corresponding to a second image portion and the first image portion itself, and the second image portion may be deleted, transmitted to another location (e.g., external server 140), and/or otherwise removed from the device performing the sequence 400 (e.g., user computing device 101).

However, it should be appreciated that the second image portion may be stored in the storage location 408 with the encoded residual and the first image portion, but the deterministic nature of the decompression models described herein (e.g., 114, 124, 402) eliminates the need to occupy the storage space required for such a data-intensive representation of the second image portion. Instead, the present techniques represented at least in part by the example compression sequence 400 enable accurate reconstruction of all higher resolution images corresponding to the first image portion through iterative application of the sequence 400.

For example, assume the first image portion has three higher resolution versions, including the second image portion with a high resolution relative to the first image portion (low resolution), a third image portion with a higher resolution than the second image portion, and a fourth image portion with the highest resolution relative to each of the other image portions. In this example, the sequence 400 may include utilizing each of the first, second, and third image portions as inputs to the deterministic generative model 402 to determine predictions and calculate residuals relative to their second, third, and fourth image portion counterparts, respectively. Namely, the first image portion may cause the model 402 to output a first generated prediction that is compared with the second image portion to generate a first residual, the second image portion may cause the model 402 to output a second generated prediction that is compared with the third image portion to generate a second residual, and the third image portion may cause the model 402 to output a third generated prediction that is compared with the fourth image portion to generate a third residual.

The encoders (e.g., encoder 120, 130) described herein may encode each of these residuals (e.g., first, second, and third residuals from prior example) and each encoded residual may be stored in the storage location 408. The only image portion stored in the storage location 408 may be the first image portion, as it represents the lowest resolution (and thereby lowest storage/file size) representation of the image portion, and each of the second, third, and fourth image portions may be deleted, transmitted to another location (e.g., external server 140), and/or otherwise removed from the device performing the sequence 400. Thus, at the end of the sequence 400, the storage location 408 may store the first image portion and three encoded residuals that may be used to reconstruct the second, third, and fourth image portions.

In certain embodiments, the encoding performed at block 406 may include entropy encoding. As previously mentioned, whole slide images generally have repeating tissue patterns and limited color variations (high visual redundancy), features that may be similarly represented in the residual characteristics generated at block 404. High visual redundancy indicates that the residual characteristics may have a more predictable and less varied distribution of values, as the images themselves have limited variability. Thus, at least in the context of WSI, entropy encoding residual characteristics can be particularly beneficial by leveraging the high visual redundancy present in the residual characteristics to encode the data efficiently. For example, and in certain embodiments, the residual characteristics may be stochastic residual characteristics representing the difference between the generated prediction and the second image portion, and the entropy encoding performed at block 406 may be configured to generate the encoded residual characteristics having a file size dependent at least in part on occurrence frequencies of data comprising the stochastic residual characteristics.

In certain embodiments, the stochastic residual characteristics may be integrated cumulative stochastic residual characteristics that are associated with the generated prediction and the second image portion. Such integrated cumulative stochastic residual characteristics may aggregate and combine multiple sources of difference information, including value differences between corresponding pixels, confidence or uncertainty metrics from the deterministic generative model, and cumulative statistical properties derived from the prediction process. These residual characteristics may be integrated and cumulative at least in that multiple sources of difference information are combined into a unified representation across multiple prediction stages or iterations of the generative model. By integrating these cumulative characteristics, the encoder may more efficiently represent the totality of information required for accurate reconstruction.

More specifically, applying entropy encoding to whole slide image residual characteristics provides a relatively lossless compression mechanism that yields several direct benefits. Entropy encoding can effectively exploit the regularities and predictability in the residual data without losing relevant details. Namely, entropy encoding may eliminate redundant information by assigning shorter codewords to more frequent symbols and longer codewords to less frequent symbols in the data, and because entropy encoding is lossless, the original information can be perfectly reconstructed upon decoding. In the case of high-redundancy residual characteristics in WSI, entropy encoding can capture these redundancies and encode them in a more compact form than other non-entropy-based encoding schemes. By efficiently encoding the whole slide image residual characteristics based on their statistical properties, entropy encoding techniques (e.g., Huffman coding, arithmetic coding, etc.) may achieve high compression ratios, reducing the storage space required for storing the residual characteristics in the storage location 408. Moreover, the compression process can effectively reduce the storage overhead while retaining the necessary information to faithfully reconstruct the high-resolution images during decompression.

FIG. 4B illustrates an example decompression sequence 420 including residual decoding and combination with the generated prediction of the higher resolution image portion in FIG. 4A, in accordance with various aspects disclosed herein. The example decompression sequence 420 includes retrieving a first image portion and an encoded residual from a storage location 422. A decoder may then decode the encoded residual (block 424), and a deterministic generative model 426 may receive the first image portion and generate a generated prediction of the first image portion. In certain embodiments, the decoding performed at block 424 may include entropy decoding.

In any event, one or more components described herein (e.g., decompression application 112 and/or model 114) may analyze this generated prediction and the decoded residual to determine the second image portion, which may be a higher resolution image portion than the first image portion (block 428). More specifically, block 428 may involve combining the decoded residual with the generated prediction to fully reconstruct the second image portion. Thus, the present techniques represented at least in part by the example decompression sequence 420 enable accurate reconstruction of higher resolution images corresponding to the first image portion through iterative application of the sequence 420.

Continuing the prior example, assume the first image portion has three higher resolution versions, including the second image portion with a high resolution relative to the first image portion (low resolution), a third image portion with a higher resolution than the second image portion, and a fourth image portion with the highest resolution relative to each of the other image portions. In this example, the sequence 420 may include utilizing each of the first, second, and third image portions as inputs to the deterministic generative model 426 to determine predictions corresponding to their second, third, and fourth image portion counterparts, respectively. The decoders (e.g., decoder 122, 132) described herein may also decode each of the encoded residuals and each decoded residual may be combined with the respective generated prediction (e.g., at block 428) to accurately reconstruct the corresponding higher resolution image portion counterpart. Namely, the first image portion may cause the model 426 to output a first generated prediction that is combined with a first decoded residual to generate the second image portion, the second image portion may cause the model 426 to output a second generated prediction that is combined with a second decoded residual to generate the third image portion, and the third image portion may cause the model 426 to output a third generated prediction that is combined with a third decoded residual to generate the fourth image portion.

As in the prior example, the only image portion stored in the storage location 422 may be the first image portion, as it represents the lowest resolution (and thereby lowest storage/file size) representation of the image portion, and each of the second and third image portions may only be utilized as inputs to the deterministic generative model 426 once themselves reconstructed by virtue of the sequence 420. Thus, at the end of the sequence 420, the systems described herein may output a complete and accurate reconstruction of the second, third, and/or fourth image portions from a starting point that includes the first image portion and encoded residuals corresponding to each of the higher resolution images.

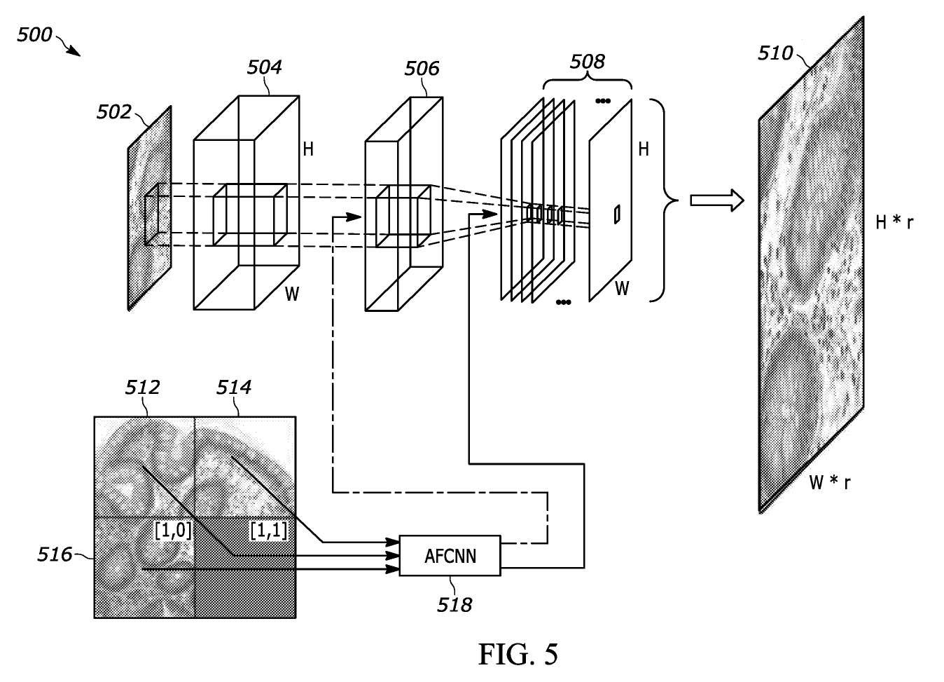

FIG. 5 illustrates an example deterministic generative model architecture 500 including a SRCNN and an optional AFCNN, in accordance with various aspects disclosed herein. The example deterministic generative model architecture 500 includes an image/image portion 502 (referenced as an “image portion” for the purposes of discussion only) that is input into a first layer 504. This first layer 504 outputs extracted features to a second layer 506 that outputs pooled features to a third layer 508 that outputs the generated prediction 510. The AFCNN 518 may optionally retrieve/receive image data from adjacent portions of an image (e.g., adjacent relative to the image portion 502), including a first adjacent image portion 512, a second adjacent image portion 514, and a third adjacent image portion 516 to output additional features (e.g., global features) that may serve as input to the second layer 506 and/or the third layer 508.

The first layer 504 may generally be a feature extraction layer configured to extract meaningful features from low-resolution input images (e.g., image portion 502). To achieve this feature extraction, the first layer 504 may apply convolutional filters to the image portion 502, which may capture relevant patterns and details. By extracting these features, the first layer 504 may at least partially enable the SRCNN to learn and reconstruct the high-resolution details that are missing in the image portion 502. For example, the first layer 504 may utilize/apply 64 initial filters on the image portion 502 to capture a diverse set of features from the image portion 502, leading to better representation learning and ultimately improve the quality of the super-resolution output generated by the SRCNN.

The second layer 506 may be an integrating layer generally configured to down-sample the extracted features from the first layer 504 to capture higher-level representations and optionally reduce computational complexity. More specifically, such an integrating layer typically reduces the dimensions of the feature maps obtained from the initial feature extraction layer (e.g., first layer 504), and by down-sampling the features, the integrating layer may help in capturing second-order features that represent more abstract and higher-level information compared to the raw pixel data of the image portion 502. The integrating layer may generate a pooled feature map that consolidates the extracted features into a more compact representation suitable for subsequent upsampling operations. For example, the second layer 506 may apply any suitable number of filters or feature maps (e.g., 32) to capture these second-order features from the output of the first layer 504 and generate the pooled feature map.

The third layer 508 may be an upsampling layer that is generally configured to transform a higher number of low-resolution features, extracted by the first and second layers 504, 506, to a low number of higher resolution features. In particular, the third layer 508 may generally increase the spatial resolution of the feature maps output by the second layer 506 to match that of the desired high-resolution output (e.g., the generated prediction 510). More specifically, the third layer 508 may be a layer that converts a lower spatial dimension and a higher feature space to a higher spatial dimension and a lower feature space, thereby transforming the compact, feature-rich representation from the integrating layer into a spatially expanded output with fewer feature channels. A possible implementation may use a strided/fractional convolution layer that generally achieves upsampling by applying fractional strides during the deconvolution operation. Unlike many convolutional layers that use integer strides for upsampling, fractional convolution allows for more precise scaling of the feature maps, resulting in a generally smoother reconstruction of the image. Fractional strides may enable the SRCNN to effectively interpolate between the low-resolution feature maps to generate high-resolution details accurately, which helps in minimizing artifacts and enhancing the quality of the super-resolved image output (e.g., generated prediction 510). In certain embodiments, the third layer 508 may upsample the pooled feature map generated by the integrating layer (e.g., second layer 506) to produce the generated prediction.

The third layer 508 may utilize any suitable scaling factor when upsampling the feature maps output by the second layer 506. In some embodiments, the scaling factor may be related to the number of subpixel layers included as part of the third layer 508. For example, the scaling factor r applied to the dimensions (e.g., height “H” and width “W”) of the image portion 502 when upsampled to the generated prediction 510 may correspond to the square root of the number of subpixel layers included as part of the third layer 508. Such subpixel layers generally help in increasing the spatial resolution of the features extracted by the SRCNN, enabling a finer reconstruction of high-frequency details. The SRCNN may combine/interweave these upsampled/scaled-up feature maps output by the subpixel layers to produce the generated prediction 510.

The AFCNN 518 may generally be configured to provide fine tuning of generated details within the SRCNN using information regarding the character/intensity of image features from adjacent image portions 512-516 to generate a higher fidelity upsampled version of the image portion 502. By incorporating details from neighboring image portions, the AFCNN 518 may provide a more comprehensive understanding of the image context (e.g., of the whole slide image) and improve the accuracy of the upsampled output. In particular, the AFCNN 518 may help refine generated details output by the SRCNN by better preserving the continuity and coherence of the image structure, leading to a higher quality and more realistic upsampled version of the targeted image section represented by the image portion 502.

Of course, it should be appreciated that this example architecture 500 is for the purposes of discussion only, and that other configurations are possible. For example, the SRCNN may include any suitable number of convolution layers, and the scaling factor applied to the image portion 502 may be any suitable value.

As another example, and in certain embodiments, the deterministic generative models described herein may include a single layer (and/or any other number of layers) configured to decompress the image portion 502 to reconstruct a second image portion. Doing so may require several steps, including utilizing a single dataset of paired high-resolution and low-resolution images for training and validation of both the multi-layer model and the single-layer model. The multi-layer model may be trained with multiple convolutional layers designed to learn the mapping between low-resolution and high-resolution image pairs, and once the multi-layer model is trained, the systems des cribbed herein may freeze the layers of this model except for the initial feature extraction layer. The systems described herein may transfer the weights of this layer, capturing essential features from low-resolution inputs, to the single-layer model.

Further in this example, the systems described herein may initialize the weights of the single-layer model with those of the feature extraction layer from the multi-layer model and continue training the single-layer model on the same dataset while allowing the model to adjust its weights to optimize the reconstruction of high-resolution details. The systems described herein may then validate the performance of the cross-trained single-layer model on a separate validation set and fine-tune as needed and may further evaluate the single-layer model’s ability to generate accurate predictions of lower resolution input images through testing on unseen/new data. By fine-tuning and/or conducting other optimization techniques, such as hyperparameter optimization, and/or model evaluation, the systems described herein may continually enhance the performance of the single-layer model in generating high-quality predictions of low-resolution images. More generally, and in certain embodiments, the systems described herein may be implemented using and/or otherwise leverage any type of derivative network that is based on an existing network architecture (e.g., deterministic generative models 114, 124), but with modifications that may, e.g., improve performance, functionality, and/or address specific requirements.

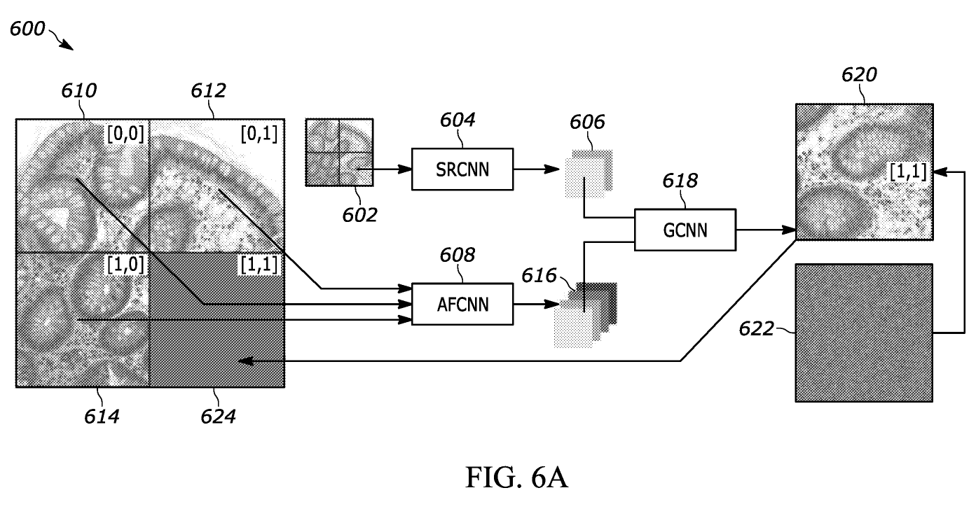

FIG. 6A illustrates an example single image portion decompression sequence 600, in accordance with various aspects disclosed herein. Generally, a subregion (index “[1,1],” as illustrated in FIG. 6A) of the overall image may be decompressed by passing the corresponding prior low-resolution layer image portion 602 through a deterministic SRCNN 604, which outputs a feature map 606 corresponding to the image portion 602. This feature map 606 may then be input into a generative CNN (GCNN) 618, which may output a generated prediction 620. The systems described herein may then combine this generated prediction 620 with a residual 622 (e.g., a stochastic residual) that, when combined with the generated prediction 620, may accurately reconstruct the higher resolution image portion 624. In certain embodiments, the GCNN 618 may be an additional layer of the SRCNN 604, similar to the strided convolution layer 508 described in FIG. 5 that is configured to upsample feature maps to output a generated prediction 510.

Additionally, the AFCNN 608 may also output feature maps 616 corresponding to one or more already decompressed adjacent subregions. For example, the AFCNN 608 may receive a first adjacent subregion image portion 610 (e.g., index “[0,0]”), a second adjacent subregion image portion 612 (e.g., index “[0,1]”), and a third adjacent subregion image portion 614 (e.g., index “[1,0]”) that are already decompressed subregions to generate feature maps 616. These feature maps 616 may be additional inputs into the GCNN 618 to inform the GCNN’s 618 output of the generated prediction 620 based on the feature maps 606 from the SRCNN 604.

Thus, as illustrated in FIG. 6A, the decompression techniques described herein may be applied layer-by-layer (e.g., in terms of resolution) to iteratively achieve higher resolution layers, and the decompression may be further enhanced by leveraging previously decompressed portions of any individual layer to better inform the decompression of other image portions within the same layer. The systems described herein may extend this iterative decompression process across multiple layers to further expedite the decompression of an entire image (e.g., whole slide image) that may be divided into a plurality of portions. For example, FIG. 6B illustrates an example iterative layer and image portion decompression sequence 630, in accordance with various aspects disclosed herein. The iterative layer and image portion decompression sequence 630 generally represents the decompression processes described elsewhere herein being iteratively performed on each layer from the lowest resolution layer to the highest simultaneously (e.g., in parallel).

The decompression sequence 630 includes a first resolution layer 632 (lowest resolution), a second resolution layer 636 (higher resolution), and a third resolution layer 640 (highest resolution). The decompression sequence 630 further includes a first set of residuals 634 corresponding to the first resolution layer 632, a second set of residuals 638 corresponding to the second resolution layer 636, and a third set of residuals 642 corresponding to the third resolution layer 640. Within each resolution layer 632, 636, and 640, the decompression process described herein may be iteratively performed for each subregion (e.g., image portion). The residuals included in the sets of residuals 634, 638, and 642 may be incorporated at the time of each image portion decompression to completely reconstruct the corresponding higher resolution layer image portion.

As generally depicted in FIG. 6B, each of the resolution layers 632, 636, and 640 and the image portions within those layers may be decompressed simultaneously as long as the higher-resolution layer’s corresponding lower-resolution image portion is already decompressed. For example, the third image portion in the third row of the second resolution layer 636 may be in the process of decompression, as described herein. In parallel, the second image portion in the second row of the third resolution layer 640 may be in the process of decompression because the second image portion in the second row of the second resolution layer 636 has already been decompressed. Moreover, the third image portion and the fourth image portion in the third row of the second resolution layer 636 may be decompressed in parallel, as the corresponding lower resolution image portions in the first resolution layer 632 have previously been decompressed.

Thus, once an image portion of a lower resolution layer has been successfully decompressed by the systems described herein, the corresponding image portion in a higher resolution layer may begin the decompression process. In performing this parallel decompression, by the time a lower resolution layer is completely decompressed, the higher resolution layer may be at least partially decompressed. The entire decompression process (e.g., from lowest resolution layer to highest resolution layer) may therefore be performed more efficiently than existing techniques that individually decompress lower resolution layers before decompressing any portion of a higher resolution image layer.

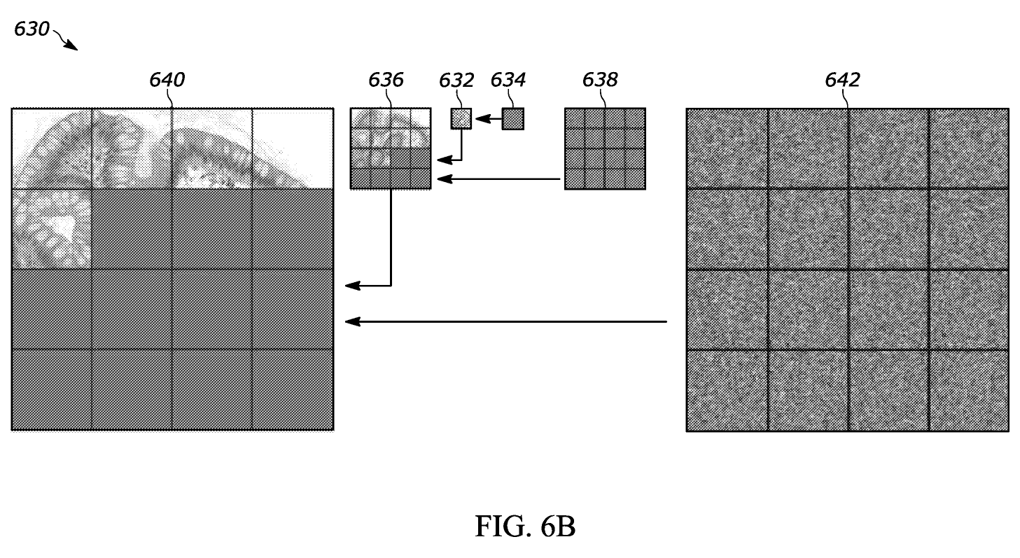

FIG. 7 illustrates a first example method 700 for improved digital image decompression, in accordance with various aspects disclosed herein. The first example method 700 is generally divided into a compression phase 702 and a decompression phase 704. The compression phase 702 generally represents the compression techniques described herein to store the lowest resolution image portion and the corresponding residuals that enable the decompression phase 704 to accurately reconstruct all higher resolution image portions.

The compression phase 702 includes receiving images representing the same features at different resolutions (block 706). For example, the images may be resolution layers of a whole slide image, where each resolution layer represents, e.g., the same tissue sample, but the different resolution layers represent the tissue sample at different resolutions. The compression phase 702 may further include analyzing the lower resolution image portions using the deterministic generative model to generate predictions (block 708). The systems described herein may then compare these generated predictions to higher resolution image portions to determine residuals that enable accurate reconstructions of the higher resolution image portions based on the generated predictions (block 710).

The compression phase 702 may further include determining whether all residuals have been determined (block 712). If less than all the required residuals have been determined (No branch of block 712), the compression phase 702 may include returning to block 708 to analyze another image portion using the deterministic generative model. However, if all residuals have been determined (Yes branch of block 712), the compression phase 702 may further include storing the lowest resolution image portion(s) and the residuals in a storage location without storing the higher resolution image portion(s) (block 714).

When the image portions previously compressed during the compression phase 702 need to be decompressed (e.g., are being viewed by a user), the first example method 700 may transition to the decompression phase 704. The decompression phase 704 may include retrieving an image portion and corresponding residual(s) from the storage location (block 716). The decompression phase 704 may further include analyzing the lowest resolution image portion through the deterministic generative model to generate the prediction (block 718). The decompression phase 704 may further include combining the generated prediction with the corresponding residual to reconstruct the corresponding higher resolution image portion (block 720).

When the higher resolution image portion has been successfully reconstructed, the systems described herein may queue the higher resolution image portion for rendering on a display for a user (block 722). The systems described herein may further determine whether to begin decompressing higher resolution image portions based on the lower resolution portions that have been previously decompressed (block 724). If the systems described herein determine that additional lower resolution image portions need to be decompressed before moving on to higher resolution image portion decompression (No branch of block 724), the decompression phase 704 may include returning to block 718, where decompression of image portions within the same resolution layer may continue. Alternatively, if the systems described herein determine that higher resolution image portion decompression can take place (Yes branch of block 724), the decompression phase 704 may further include analyzing higher resolution image portions using the deterministic generative models described herein (block 726).

It should be appreciated that the actions performed and/or described herein in reference to the first example method 700 of FIG. 7 may be performed any suitable number of times and/or in any suitable order. For example, the actions associated with the compression phase 702 and/or the decompression phase 704 may be performed any suitable number of times to achieve accurate compression/decompression of any suitable number of resolution layers.

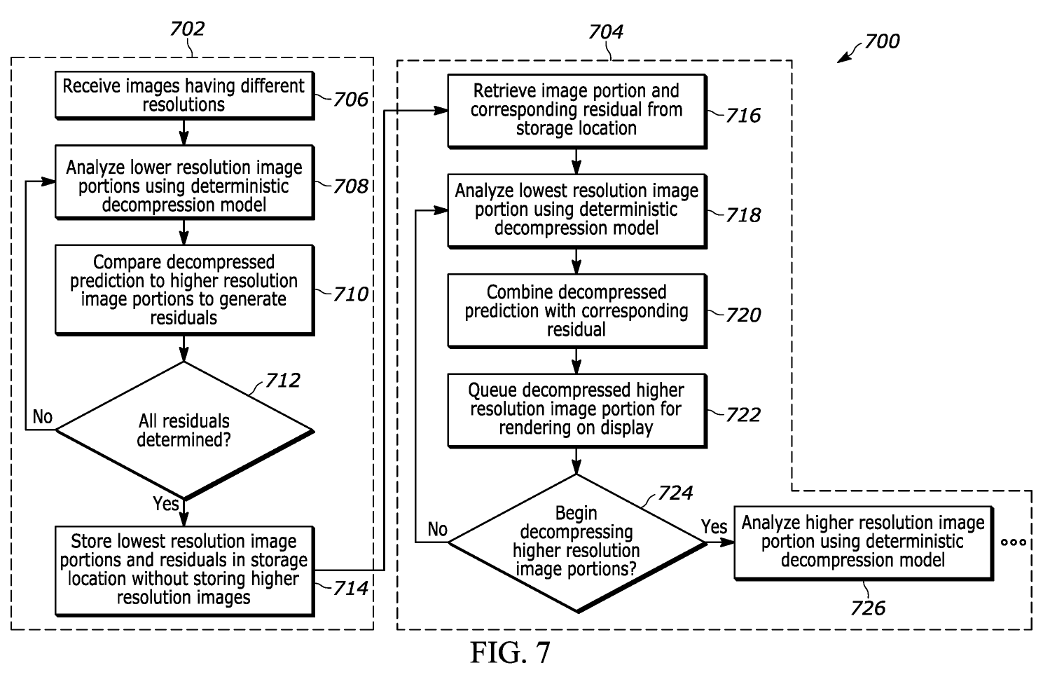

FIG. 8 illustrates an example method 800 for generative improved super resolution digital image compression, in accordance with various aspects disclosed herein. For ease of discussion, some of the various actions included in the method 800 may be optional and may be described herein as performed by or with the use of a processor (e.g., processor 102). However, it is to be appreciated that the various actions included in the method 800 may be performed by, for example, a specific processing unit (e.g., CPU 102a, GPU 102b) executing the decompression application 112 and/or the deterministic generative models 114, 124, an external server (e.g., external server 140), and/or other suitable processors or combinations thereof.

The method 800 may include generating, using a deterministic generative model and a first image portion having a first resolution, a prediction of a second image portion having a second resolution that is higher than the first resolution (block 802). The method 800 may further include encoding, using an encoder, a residual for the generated prediction (block 804). The residual may represent a difference between the generated prediction and the second image portion. The method 800 may further include storing the first image portion and the encoded residual in a storage location without storing the second image portion (block 806).

The method 800 may further include decompressing the first image portion to reconstruct the second image portion at least in part by retrieving the first image portion and the encoded residual from the storage location (block 808). The method 800 may further include decompressing the first image portion to reconstruct the second image portion at least in part by generating, using the deterministic generative model and based on the first image portion, the generated prediction (block 810). The method 800 may further include decompressing the first image portion to reconstruct the second image portion at least in part by combining the encoded residual with the generated prediction to reconstruct the second image portion (block 812).

In certain embodiments, the method 800 may further include training the deterministic generative model using a plurality of training data, wherein the plurality of training data comprises as single image data type to minimize information entropy.

In certain embodiments, the residual may be a stochastic residual representing the difference between the generated prediction and the second image portion; and the encoder may be an entropy encoder configured to generate the encoded residual having a file size dependent at least in part on occurrence frequencies of data comprising the stochastic residual.

In certain embodiments, generating the prediction may further include extracting, by the one or more processors executing operations of a feature extraction layer of the deterministic generative model, features of the first image portion into a feature map; generating, by the one or more processors executing operations of an integrating layer of the deterministic generative model, a pooled feature map of the first image portion; and upsampling, by the one or more processors executing operations of a layer of the deterministic generative model that converts a lower spatial dimension and a higher feature space to a higher spatial dimension and a lower feature space, the pooled feature map of the first image portion.

In certain embodiments, upsampling the pooled feature map may further include generating, by the one or more processors using an adjacent feature deterministic feature model, an adjacent feature map associated with at least one image portion that is adjacent to the first image portion; and upsampling, by the one or more processors based at least in part on the adjacent feature map, the pooled feature map of the first image portion.

In certain embodiments, generating the prediction may be based at least in part on (i) a downsampled image portion corresponding to the first image portion, (ii) the encoded residual, and/or (iii) a decompressed image portion corresponding to an image portion that is proximate to the first image portion, the decompressed image portion having been mixed with an associated residual.

In certain embodiments, the method 800 may further include decompressing in parallel (i) the first image portion to reconstruct the second image portion and (ii) a third image portion to reconstruct a fourth image portion, wherein the third image portion has the first resolution and the fourth image portion has the second resolution.

In certain embodiments, the deterministic generative model is a first deterministic generative model, and the method 800 may further include generating, by one or more processors using a second deterministic generative model and the second image portion, a second prediction of a fifth image portion having a third resolution that is higher than the second resolution, the second deterministic generative model being different from the first deterministic generative model; encoding, by the one or more processors using the encoder, a second residual for the second prediction, the second residual representing a difference between the second prediction and the fifth image portion; storing, by the one or more processors, the second image portion and the encoded second residual in the storage location without storing the fifth image portion; and decompressing, by the one or more processors using the second deterministic generative model, the second image portion to reconstruct the fifth image portion.

In certain embodiments, the deterministic generative model may include a single layer configured to decompress the first image portion to reconstruct the second image portion.

In certain embodiments, the encoder may be an entropy encoder, and mixing the encoded residual with the generated prediction may further include decoding, by the one or more processors using an entropy decoder, the encoded residual; and combining the decoded residual with the generated prediction to reconstruct the second image portion.

In certain embodiments, the deterministic generative model may include a generative neural network that incorporates a SRCNN and an AFCNN to create the generated prediction.

In certain embodiments, the first image portion may have a first file size; the second image portion may have a second file size; the residual may have a third file size; and the second file size may be greater than a combination of the first file size and the third file size.

It should be appreciated that the actions performed and/or described herein in reference to the method 800 of FIG. 8 may be performed any suitable number of times and/or in any suitable order.

In certain embodiments, the one or more processors may comprise a GPU, and the decompression techniques described herein may leverage GPU textures to achieve enhanced performance and efficiency. GPU texture decompression and rendering techniques involve loading image portions directly into GPU memory as GPU textures, which may serve dual purposes within the decompression and rendering pipelines described herein. A GPU texture may be a specialized data structure stored in GPU memory that is optimized for graphics operations and may be accessed efficiently by both rendering pipelines and computational processes such as the deterministic generative models described herein.

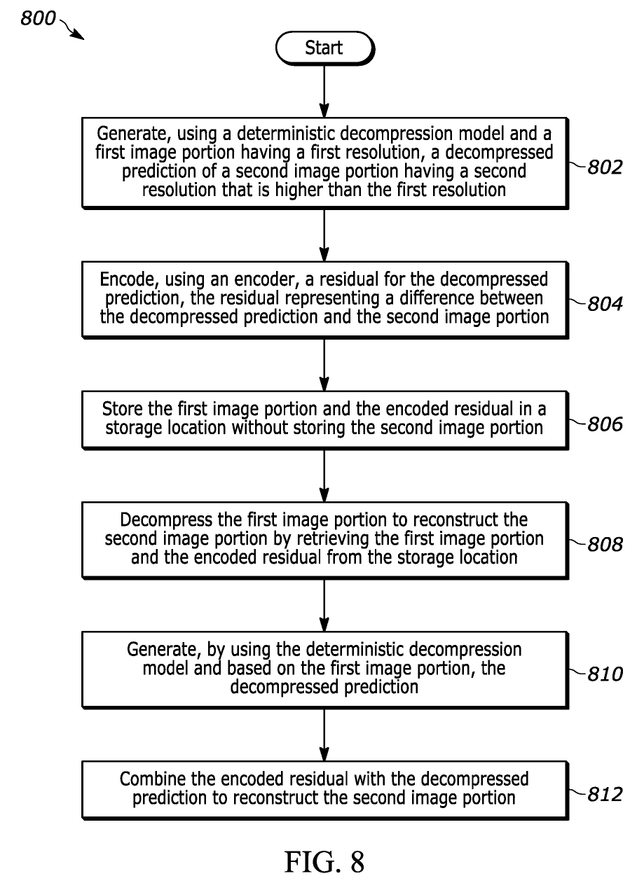

For example, FIG. 9 depicts an example multiuse GPU texture workflow 900, in accordance with various aspects disclosed herein. The GPU texture-based approach depicted in FIG. 9 may function by loading the first image portion into GPU memory as a GPU texture (block 902), where it may remain resident throughout the decompression and rendering processes. The GPU may utilize this same GPU texture to render the first image portion on a display without requiring data transfers between the GPU memory and a central processing unit (CPU) (block 904). Additionally, the deterministic generative models described herein may use the GPU texture as input data to generate predictions of higher resolution image portions (block 906). This process may continue iteratively, where the GPU may utilize a single GPU texture to both render corresponding image portions and serve as input for the deterministic generative model to generate higher-resolution layer image portions (block 908). Thus, each of the processes depicted within block 910 may take place on the GPU without transferring the image portions or textures to/from the CPU.

In particular, this GPU texture approach depicted in FIG. 9 may differ significantly from many techniques that require multiple data transfers between CPU and GPU memory during decompression and rendering operations. Namely, existing methods often involve loading image data into CPU memory, processing it through decompression algorithms, transferring the processed data to GPU memory for rendering, and potentially transferring data back to CPU memory for further processing. In contrast, the present GPU texture techniques may reduce the number of transfers to and from the GPU by maintaining image data as GPU textures throughout the entire decompression and rendering pipeline. This approach may minimize memory bandwidth usage, reduce processing latency, and improve overall system performance by eliminating redundant data transfers that are characteristic of existing decompression and rendering workflows.

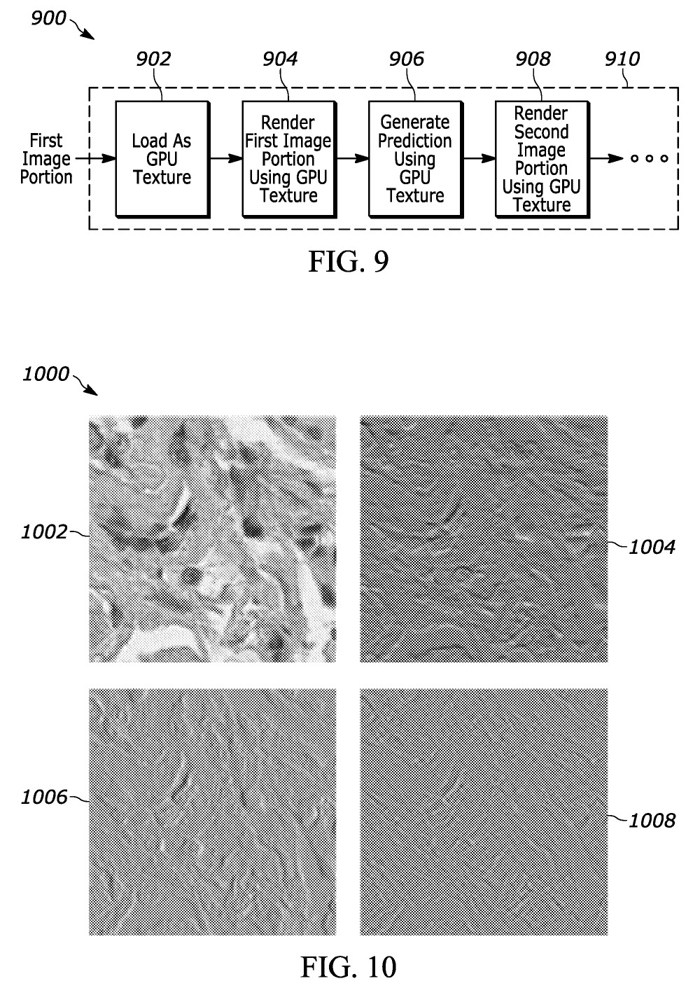

In certain embodiments, the deterministic generative models described herein may incorporate frequency transform techniques to enhance the prediction accuracy and compression efficiency of the super-resolution process. For example, FIG. 10 depicts an example frequency coefficient prediction workflow 1000, in accordance with various aspects disclosed herein. Frequency transforms, such as wavelet transforms, may provide a mathematical framework for decomposing image data into different frequency components that represent various levels of detail and spatial information within the image. These transforms may convert spatial domain image data into frequency domain representations, where different frequency coefficients correspond to different scales and orientations of image features.

The frequency transform process may function by applying mathematical operations that analyze the image content at multiple resolution levels simultaneously. When a frequency transform is applied to decompose the first image portion into a first set of frequency coefficients, the transform may separate the image into distinct frequency bands that capture different types of visual information. Each frequency coefficient may represent the strength or amplitude of specific frequency components within the original image data, enabling the deterministic generative model to analyze and process these components independently.

For example, the example frequency coefficient prediction workflow 1000 may include generating four distinct passes or subbands that correspond to different frequency characteristics of the image data. The LL pass 1002 may represent the low-frequency components in both horizontal and vertical directions, containing the coarse approximation of the image with smooth variations and overall structure. The LH pass 1004 may capture low-frequency components in the horizontal direction and high-frequency components in the vertical direction, typically representing horizontal edges and vertical details. The HL pass 1006 may contain high-frequency components in the horizontal direction and low-frequency components in the vertical direction, generally corresponding to vertical edges and horizontal details. The HH pass 1008 may represent high-frequency components in both directions, capturing diagonal details, textures, and fine-grained features within the image.

As illustrated in FIG. 10, the deterministic generative model may utilize the LL pass 1002 as the low-resolution image input for the lower-resolution pyramid layer, while predicting the LH pass 1004, the HL pass 1006, and/or the HH pass 1008 components. This approach may enable the models to focus on generating the high-frequency detail components that are typically lost during conventional downsampling operations. The neural networks described herein may analyze the LL pass 1002 to understand the overall image structure and then generate predictions for the three high-frequency passes 1004-1008 that contain the detailed information necessary for accurate super-resolution reconstruction.

The deterministic generative model may generate, based on the first set of frequency coefficients, a second set of frequency coefficients corresponding to the second image portion. This generation process may involve the model learning to predict how the frequency components should be enhanced or modified to achieve the higher resolution output. The model may analyze the relationships between different frequency bands and generate appropriate coefficients that represent the enhanced detail and resolution characteristics of the target image portion. The components described herein may then apply an inverse frequency transform to convert the second set of frequency coefficients back to the spatial domain to produce the prediction of the second image portion. This reconstruction process may combine the predicted frequency components to synthesize the higher resolution image data, where the inverse transform operations may aggregate the various frequency bands into a coherent spatial representation that approximates the desired high-resolution output.

In this frequency-based approach, the residual may represent a difference between the second set of frequency coefficients and a set of actual frequency coefficients of the second image portion. This frequency domain residual calculation may offer advantages over spatial domain residuals by capturing the specific frequency components where the prediction differs from the ground truth data. In certain instances, the frequency domain representation of residuals may be more compact and efficient for encoding, particularly when the prediction accuracy varies across different frequency bands. In particular, many frequency coefficients may have zero or near-zero values, particularly in the high-frequency passes, which may enable more efficient processing and storage. The sparsity of frequency domain representations may thus allow the deterministic generative model to focus computational resources on the most significant coefficients while efficiently handling the numerous zero-valued components, potentially leading to improved compression ratios and/or faster processing compared to dense spatial domain approaches.

### Aspects of the Present Disclosure

Aspect 1. A computer-implemented method for generative improved super resolution digital image compression, the computer-implemented method comprising: generating, by one or more processors using a deterministic generative model and a first image portion having a first resolution, a prediction of a second image portion having a second resolution that is higher than the first resolution; encoding, by the one or more processors using an encoder, residual characteristics for the generated prediction, the residual characteristics representing differences between the generated prediction and the second image portion; storing, by the one or more processors, the first image portion and the encoded residual characteristics in a storage location without storing the second image portion; and decompressing, by the one or more processors, the first image portion to reconstruct the second image portion by: retrieving the first image portion and the encoded residual characteristics from the storage location, generating, by using the deterministic generative model and based on the first image portion, the generated prediction, and combining the encoded residual characteristics with the generated prediction to reconstruct the second image portion.

Aspect 2. The computer-implemented method of aspect 1, further comprising: training, by the one or more processors, the deterministic generative model using a plurality of training data, wherein the plurality of training data comprises as single image data type to minimize information entropy.

Aspect 3. The computer-implemented method of aspect 1 or 2, wherein: the residual characteristics are integrated cumulative stochastic residual characteristics associated with the generated prediction and the second image portion; and the encoder is an entropy encoder configured to generate the encoded residual characteristics having a file size dependent at least in part on occurrence frequencies of data comprising the integrated cumulative stochastic residual characteristics.

Aspect 4. The computer-implemented method of any of aspects 1 through 3, wherein generating the prediction further comprises: extracting, by the one or more processors executing operations of a feature extraction layer of the deterministic generative model, features of the first image portion into a feature map; generating, by the one or more processors executing operations of an integrating layer of the deterministic generative model, a pooled feature map of the first image portion; and upsampling, by the one or more processors executing operations of a layer of the deterministic generative model that converts a lower spatial dimension and a higher feature space to a higher spatial dimension and a lower feature space, the pooled feature map of the first image portion.

Aspect 5. The computer-implemented method of aspect 4, wherein upsampling the pooled feature map further comprises: generating, by the one or more processors using an adjacent feature deterministic feature model, an adjacent feature map associated with at least one image portion that is adjacent to the first image portion; and upsampling, by the one or more processors based at least in part on the adjacent feature map, the pooled feature map of the first image portion.

Aspect 6. The computer-implemented method of any of aspects 1 through 5, wherein generating the prediction is based at least in part on (i) a downsampled image portion corresponding to the first image portion, (ii) the encoded residual characteristics, and (iii) a decompressed image portion corresponding to an image portion that is proximate to the first image portion, the decompressed image portion having been mixed with associated residual characteristics.

Aspect 7. The computer-implemented method of any of aspects 1 through 6, further comprising: decompressing in parallel, by the one or more processors, (i) the first image portion to reconstruct the second image portion and (ii) a third image portion to reconstruct a fourth image portion, wherein the third image portion has the first resolution and the fourth image portion has the second resolution.

Aspect 8. The computer-implemented method of any of aspects 1 through 7, wherein the deterministic generative model is a first deterministic generative model, and the computer-implemented method further comprises: generating, by one or more processors using a second deterministic generative model and the second image portion, a second prediction of a fifth image portion having a third resolution that is higher than the second resolution, the second deterministic generative model being different from the first deterministic generative model; encoding, by the one or more processors using the encoder, second residual characteristics for the second prediction, the second residual characteristics representing differences between the second prediction and the fifth image portion; storing, by the one or more processors, the second image portion and the encoded second residual characteristics in the storage location without storing the fifth image portion; and decompressing, by the one or more processors using the second deterministic generative model, the second image portion to reconstruct the fifth image portion.

Aspect 9. The computer-implemented method of any of aspects 1 through 8, wherein the deterministic generative model includes a single layer configured to decompress the first image portion to reconstruct the second image portion.

Aspect 10. The computer-implemented method of any of aspects 1 through 9, wherein the encoder is an entropy encoder, and wherein mixing the encoded residual characteristics with the generated prediction further comprises: decoding, by the one or more processors using an entropy decoder, the encoded residual characteristics; and combining the decoded residual characteristics with the generated prediction to reconstruct the second image portion.

Aspect 11. The computer-implemented method of any of aspects 1 through 10, wherein the deterministic generative model comprises a generative neural network that incorporates a super resolution convolutional neural network (SRCNN) and an adjacent feature convolutional neural network (AFCNN) to create the generated prediction.

Aspect12. The computer-implemented method of any of aspects 1 through 11, wherein: the first image portion has a first file size; the second image portion has a second file size; the residual characteristics have a third file size; and the second file size is greater than a combination of the first file size and the third file size.

Aspect 13. A system for generative improved super resolution digital image compression, the system comprising: one or more processors; and at least one memory storing processor-executable instructions that, when executed by the one or more processors, cause the one or more processors to perform operations comprising: generating, using a deterministic generative model and a first image portion having a first resolution, a prediction of a second image portion having a second resolution that is higher than the first resolution; encoding, using an encoder, residual characteristics for the generated prediction, the residual characteristics representing differences between the generated prediction and the second image portion; storing the first image portion and the encoded residual characteristics in a storage location without storing the second image portion; and decompressing the first image portion to reconstruct the second image portion by: retrieving the first image portion and the encoded residual characteristics from the storage location, generating, by using the deterministic generative model and based on the first image portion, the generated prediction, and combining the encoded residual characteristics with the generated prediction to reconstruct the second image portion.

Aspect 14. The system of aspect 13, wherein the processor-executable instructions, when executed by the one or more processors, further cause the one or more processors to perform operations comprising: training the deterministic generative model using a plurality of training data, wherein the plurality of training data comprises as single image data type to minimize information entropy.

Aspect 15. The system of aspect 13 or 14, wherein: the residual characteristics are integrated cumulative stochastic residual characteristics associated with the generated prediction and the second image portion; and the encoder is an entropy encoder configured to generate the encoded residual characteristics having a file size dependent at least in part on occurrence frequencies of data comprising the integrated cumulative stochastic residual characteristics.

Aspect 16. The system of any of aspects 13 through 15, wherein generating the prediction further comprises: extracting, by executing operations of a feature extraction layer of the deterministic generative model, features of the first image portion into a feature map; generating, by executing operations of an integrating layer of the deterministic generative model, a pooled feature map of the first image portion; and upsampling, by executing operations of a layer of the deterministic generative model that converts a lower spatial dimension and a higher feature space to a higher spatial dimension and a lower feature space, the pooled feature map of the first image portion.

Aspect 17. The system of aspect 16, wherein upsampling the downsampled feature map further comprises: generating, using an adjacent feature deterministic feature model, an adjacent feature map associated with at least one image portion that is adjacent to the first image portion; and upsampling, based at least in part on the adjacent feature map, the downsampled feature map of the first image portion.

Aspect 18. The system of any of aspects 13 through 17, wherein generating the prediction is based at least in part on (i) a downsampled image portion corresponding to the first image portion, (ii) the encoded residual characteristics, and (iii) a decompressed image portion corresponding to an image portion that is proximate to the first image portion, the decompressed image portion having been mixed with associated residual characteristics.

Aspect 19. The system of any of aspects 13 through 18, wherein the processor-executable instructions, when executed by the one or more processors, further cause the one or more processors to perform operations comprising: decompressing in parallel (i) the first image portion to reconstruct the second image portion and (ii) a third image portion to reconstruct a fourth image portion, wherein the third image portion has the first resolution and the fourth image portion has the second resolution.

Aspect 20. One or more non-transitory computer-readable media storing processor-executable instructions that, when executed by one or more processors, cause the one or more processors to perform operations comprising: generating, using a deterministic generative model and a first image portion having a first resolution, a prediction of a second image portion having a second resolution that is higher than the first resolution; encoding, using an encoder, residual characteristics for the generated prediction, the residual characteristics representing differences between the generated prediction and the second image portion; storing the first image portion and the encoded residual characteristics in a storage location without storing the second image portion; and decompressing the first image portion to reconstruct the second image portion by: retrieving the first image portion and the encoded residual characteristics from the storage location, generating, by using the deterministic generative model and based on the first image portion, the generated prediction, and combining the encoded residual characteristics with the generated prediction to reconstruct the second image portion.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term "hardware module" should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as "processing," "computing," "calculating," "determining," "presenting," "displaying," or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to "one embodiment" or "an embodiment" means that a particular element, feature, structure, or characteristic described in connection with the embodiment is included in at least one embodiment. The appearances of the phrase "in one embodiment" in various places in the specification are not necessarily all referring to the same embodiment.

Some embodiments may be described using the expression "coupled" and "connected" along with their derivatives. For example, some embodiments may be described using the term "coupled" to indicate that two or more elements are in direct physical or electrical contact. The term "coupled," however, may also mean that two or more elements are not in direct contact with each other, but yet still co-operate or interact with each other. The embodiments are not limited in this context.

As used herein, the terms "comprises," "comprising," "includes," "including," "has," "having" or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, "or" refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the "a" or "an" are employed to describe elements and components of the embodiments herein. This is done merely for convenience and to give a general sense of the description. This description, and the claims that follow, should be read to include one or at least one and the singular also includes the plural unless it is obvious that it is meant otherwise.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding; and no unnecessary limitations should be understood therefrom, as modifications within the scope of the invention may be apparent to those having ordinary skill in the art.

What is claimed is:

1. A computer-implemented method for generative improved super resolution digital image compression, the computer-implemented method comprising:
generating, by one or more processors using a deterministic generative model and a first image portion having a first resolution, a prediction of a second image portion having a second resolution that is higher than the first resolution;
encoding, by the one or more processors using an encoder, residual characteristics for the generated prediction, the residual characteristics representing differences between the generated prediction and the second image portion;
storing, by the one or more processors, the first image portion and the encoded residual characteristics in a storage location without storing the second image portion; and
decompressing, by the one or more processors, the first image portion to reconstruct the second image portion by:
retrieving the first image portion and the encoded residual characteristics from the storage location,
generating, by using the deterministic generative model and based on the first image portion, the generated prediction, and
combining the encoded residual characteristics with the generated prediction to reconstruct the second image portion.

2. The computer-implemented method of claim 1, further comprising:
training, by the one or more processors, the deterministic generative model using a plurality of training data, wherein the plurality of training data comprises as single image data type to minimize information entropy.

3. The computer-implemented method of claim 1, wherein:
the residual characteristics are integrated cumulative stochastic residual characteristics associated with the generated prediction and the second image portion; and
the encoder is an entropy encoder configured to generate the encoded residual characteristics having a file size dependent at least in part on occurrence frequencies of data comprising the integrated cumulative stochastic residual characteristics.

4. The computer-implemented method of claim 1, wherein generating the prediction further comprises:
extracting, by the one or more processors executing operations of a feature extraction layer of the deterministic generative model, features of the first image portion into a feature map;
generating, by the one or more processors executing operations of an integrating layer of the deterministic generative model, a pooled feature map of the first image portion; and
upsampling, by the one or more processors executing operations of a layer of the deterministic generative model that converts a lower spatial dimension and a higher feature space to a higher spatial dimension and a lower feature space, the pooled feature map of the first image portion.

5. The computer-implemented method of claim 4, wherein upsampling the pooled feature map further comprises:
generating, by the one or more processors using an adjacent feature deterministic feature model, an adjacent feature map associated with at least one image portion that is adjacent to the first image portion; and
upsampling, by the one or more processors based at least in part on the adjacent feature map, the pooled feature map of the first image portion.

6. The computer-implemented method of claim 1, wherein generating the prediction is based at least in part on (i) a downsampled image portion corresponding to the first image portion, (ii) the encoded residual characteristics, and (iii) a decompressed image portion corresponding to an image portion that is proximate to the first image portion, the decompressed image portion having been mixed with associated residual characteristics.

7. The computer-implemented method of claim 1, further comprising:
decompressing in parallel, by the one or more processors, (i) the first image portion to reconstruct the second image portion and (ii) a third image portion to reconstruct a fourth image portion, wherein the third image portion has the first resolution and the fourth image portion has the second resolution.

8. The computer-implemented method of claim 1, wherein the deterministic generative model is a first deterministic generative model, and the computer-implemented method further comprises:
generating, by one or more processors using a second deterministic generative model and the second image portion, a second prediction of a fifth image portion having a third resolution that is higher than the second resolution, the second deterministic generative model being different from the first deterministic generative model;
encoding, by the one or more processors using the encoder, second residual characteristics for the second prediction, the second residual characteristics representing differences between the second prediction and the fifth image portion;
storing, by the one or more processors, the second image portion and the encoded second residual characteristics in the storage location without storing the fifth image portion; and
decompressing, by the one or more processors using the second deterministic generative model, the second image portion to reconstruct the fifth image portion.

9. The computer-implemented method of claim 1, wherein
the deterministic generative model includes a single layer configured to decompress the first image portion to reconstruct the second image portion.

10. The computer-implemented method of claim 1, wherein the encoder is an entropy encoder, and wherein mixing the encoded residual characteristics with the generated prediction further comprises:
decoding, by the one or more processors using an entropy decoder, the encoded residual characteristics; and
combining the decoded residual characteristics with the generated prediction to reconstruct the second image portion.

11. The computer-implemented method of claim 1, wherein the deterministic generative model comprises: (i) a generative neural network, (ii) a polynomial interpolation, or (iii) a combination of (i) and (ii).

12. The computer-implemented method of claim 1, wherein:
the first image portion has a first file size;
the second image portion has a second file size;
the residual characteristics have a third file size; and
the second file size is greater than a combination of the first file size and the third file size.

13. The computer-implemented method of claim 1, wherein:
the one or more processors comprise a graphics processing unit (GPU); and
decompressing the first image portion to reconstruct the second image portion further comprises:
loading the first image portion into a GPU texture in GPU memory,
rendering, using the GPU texture, the first image portion on a display without transferring the first image portion between the GPU memory and a central processing unit (CPU), and
generating the generated prediction using the GPU texture as input data for the deterministic generative model.

14. The computer-implemented method of claim 1, wherein generating the prediction further comprises:
applying a frequency transform to decompose the first image portion into a first set of frequency coefficients;
generating, using the deterministic generative model and based on the first set of frequency coefficients, a second set of frequency coefficients corresponding to the second image portion; and
applying an inverse frequency transform to convert the second set of frequency coefficients to the prediction of the second image portion, and
wherein the residual characteristics represent differences between the second set of frequency coefficients and a set of actual frequency coefficients of the second image portion.

15. A system for generative improved super resolution digital image compression, the system comprising:
one or more processors; and
at least one memory storing processor-executable instructions that, when executed by the one or more processors, cause the one or more processors to perform operations comprising:
generating, using a deterministic generative model and a first image portion having a first resolution, a prediction of a second image portion having a second resolution that is higher than the first resolution;
encoding, using an encoder, residual characteristics for the generated prediction, the residual characteristics representing differences between the generated prediction and the second image portion;
storing the first image portion and the encoded residual characteristics in a storage location without storing the second image portion; and
decompressing the first image portion to reconstruct the second image portion by:
retrieving the first image portion and the encoded residual characteristics from the storage location,
generating, by using the deterministic generative model and based on the first image portion, the generated prediction, and
combining the encoded residual characteristics with the generated prediction to reconstruct the second image portion.

16. The system of claim 15, wherein the processor-executable instructions, when executed by the one or more processors, further cause the one or more processors to perform operations comprising:
training the deterministic generative model using a plurality of training data, wherein the plurality of training data comprises as single image data type to minimize information entropy.

17. The system of claim 15, wherein:
the residual characteristics are integrated cumulative stochastic residual characteristics associated with the generated prediction and the second image portion; and
the encoder is an entropy encoder configured to generate the encoded residual characteristics having a file size dependent at least in part on occurrence frequencies of data comprising the integrated cumulative stochastic residual characteristics.

18. The system of claim 15, wherein generating the prediction further comprises:
extracting, by executing operations of a feature extraction layer of the deterministic generative model, features of the first image portion into a feature map;
generating, by executing operations of an integrating layer of the deterministic generative model, a pooled feature map of the first image portion; and
upsampling, by executing operations of a layer of the deterministic generative model that converts a lower spatial dimension and a higher feature space to a higher spatial dimension and a lower feature space, the pooled feature map of the first image portion by:
generating, using an adjacent feature deterministic feature model, an adjacent feature map associated with at least one image portion that is adjacent to the first image portion, and
upsampling, based at least in part on the adjacent feature map, the pooled feature map of the first image portion.

19. The system of claim 15, wherein generating the prediction is based at least in part on (i) a downsampled image portion corresponding to the first image portion, (ii) the encoded residual characteristics, and (iii) a decompressed image portion corresponding to an image portion that is proximate to the first image portion, the decompressed image portion having been mixed with associated residual characteristics.

20. One or more non-transitory computer-readable media storing processor-executable instructions that, when executed by one or more processors, cause the one or more processors to perform operations comprising:
generating, using a deterministic generative model and a first image portion having a first resolution, a prediction of a second image portion having a second resolution that is higher than the first resolution;
encoding, using an encoder, residual characteristics for the generated prediction, the residual characteristics representing differences between the generated prediction and the second image portion;
storing the first image portion and the encoded residual characteristics in a storage location without storing the second image portion; and
decompressing the first image portion to reconstruct the second image portion by:
retrieving the first image portion and the encoded residual characteristics from the storage location,
generating, by using the deterministic generative model and based on the first image portion, the generated prediction, and
combining the encoded residual characteristics with the generated prediction to reconstruct the second image portion.
